(19) United States
(12) Patent Application Publication
(10) Pub. No.: US 2026/0222504 A1
(43) Pub. Date: Jul. 30, 2026

(54) IMAGE READING APPARATUS

(71) Applicant: SEIKO EPSON CORPORATION, Tokyo (JP)

(72) Inventors: Rei TSUTSUI, KITAKYUSHU-SHI (JP); Noriyuki KOYANAGI, KITAKYUSHU-SHI (JP); Tsuneo KASAI, AZUMINO-SHI (JP); Masatomo KANAMITSU, KITAKYUSHU-SHI (JP)

(21) Appl. No.: 19/460,543

(22) Filed: Jan. 27, 2026

(30) Foreign Application Priority Data
Jan. 30, 2025 (JP) 2025-013744

(51) Int. Cl. H04N 1/00; H04N 1/10

(52) U.S. Cl. CPC H04N 1/00822; H04N 1/00482; H04N 1/00551; H04N 1/00811; H04N 1/00814; H04N 1/00824; H04N 1/1061; H04N 2201/0081

(57) ABSTRACT

The image reading apparatus includes a document table, a document cover, a reading unit, and a control unit. The document table has a placement surface on which a document is to be placed. The document cover opens and closes the placement surface of the document table. The reading unit reads a document placed on the placement surface of the document table on an opposite side from the placement surface. When a mode in which reading of a plurality of documents is continuously performed for each of the documents in an open state in which the document cover is opened with respect to the document table is selected, the control unit ends the mode based on a predetermined condition being satisfied in a removal waiting state in which a document for which reading is ended is to be removed from the document table.

The present application is based on, and claims priority from JP Application Serial Number 2025-013744, filed January 30, 2025, the disclosure of which is hereby incorporated by reference herein in its entirety.

### BACKGROUND

### 1. Technical Field

The present disclosure relates to an image reading apparatus including a reading unit that reads a document.

### 2. Related Art

For example, U.S. Patent Application Publication No. 2021/0084179 discloses an immediate execution mode in which, in an image reading apparatus, when a predetermined standby time elapses after a sensor detects that a document is placed at a predetermined position on a document table, a reading unit starts a document reading process. The immediate execution mode is canceled when a user removes the document or opens a document cover.

U.S. Patent Application Publication No. 2021/0084179 is an example of the related art.

However, when a plurality of pages of a booklet such as a book are to be read continuously for each page, it is inconvenient to cancel the process every time the pages of the booklet are changed. In this regard, when a plurality of pages of a booklet are read continuously for each page, there is room for improvement in terms of user convenience.

### SUMMARY

According to an aspect of the present disclosure, there is provided an image reading apparatus including: a document table having a placement surface on which a document is to be placed; a document cover configured to open and close the placement surface of the document table; a reading unit configured to read a document placed on the placement surface of the document table on an opposite side from the placement surface; and a control unit. When a mode in which reading of a plurality of documents is continuously performed for each of the documents in an open state in which the document cover is opened with respect to the document table is selected, the control unit ends the mode based on a predetermined condition being satisfied in a removal waiting state in which a document for which reading is ended is to be removed from the document table.

According to an aspect of the present disclosure, there is provided an image reading apparatus including: a document table having a placement surface on which a document is to be placed; a document cover configured to open and close the placement surface of the document table; a reading unit configured to read a document placed on the placement surface of the document table on an opposite side from the placement surface; and a control unit. When a mode in which reading of a plurality of documents is continuously performed for each of the documents in an open state in which the document cover is opened with respect to the document table is selected, the control unit ends the mode based on an instruction issued by a user to end in any one of a document cover open waiting state in which the open state of the document cover is waited, a placement waiting state in which placement of a document on the document table is waited, a removal waiting state in which the document for which reading is ended is to be removed from the document table, and a post-cancellation instruction waiting state in which an instruction is waited after the reading of a document is cancelled by the user.

### BRIEF DESCRIPTION OF THE DRAWINGS

FIG. 1 is a schematic front cross-sectional view illustrating an image reading apparatus according to a first embodiment.

FIG. 2 is a schematic perspective view illustrating the image reading apparatus in which a document cover is in an open state.

FIG. 3 is a partially cutaway schematic front view of the image reading apparatus on which a book is placed as a document.

FIG. 4 is a schematic plan view illustrating a configuration of a reading module.

FIG. 5 is a block diagram illustrating an electrical configuration of the image reading apparatus.

FIG. 6 is a state transition diagram illustrating a state transition in a book scan mode of the image reading apparatus.

FIG. 7 is a schematic view illustrating a selection screen for a document standby mode.

FIG. 8 is a schematic view illustrating a first setting screen for setting a standby time.

FIG. 9 is a schematic view illustrating a second setting screen for setting the standby time.

FIG. 10 is a flowchart illustrating a book scan processing routine.

FIG. 11 is a schematic view illustrating a guidance screen for prompting an opening operation of the document cover.

FIG. 12 is a schematic view illustrating a guidance screen for guiding placement of the document.

FIG. 13 is a schematic plan view illustrating the image reading apparatus before the document is placed.

FIG. 14 is a schematic plan view illustrating the image reading apparatus when a document is placed.

FIG. 15 is a diagram of a document detection process performed in a state in which the document cover is in the open state, and is a schematic view of an image reading apparatus on which a book is placed and a graph illustrating read data of a reading unit.

FIG. 16 is a schematic view illustrating a notification screen for notifying that scanning is in progress.

FIG. 17 is a schematic view illustrating a guidance screen for guiding removal of the document.

FIG. 18 is a schematic view illustrating a guidance screen for guiding the placement of the document.

FIG. 19 is a flowchart illustrating the book scan processing routine.

FIG. 20 is a flowchart illustrating the book scan processing routine.

FIG. 21 is a schematic view illustrating the notification screen for notifying that scanning is in progress.

FIG. 22 is a schematic view illustrating a notification screen for notifying that cancellation is in progress.

FIG. 23 is a schematic view illustrating a notification screen for notifying that the scanning is completed.

FIG. 24 is a flowchart illustrating a book scan processing routine in a second embodiment.

FIG. 25 is a state transition diagram illustrating a state transition in the book scan mode of the image reading apparatus.

FIG. 26 is a schematic view illustrating a confirmation screen after cancellation.

FIG. 27 is a flowchart illustrating a book scan processing routine in a third embodiment.

FIG. 28 is a schematic view illustrating a guidance screen for guiding placement of a document.

FIG. 29 is a flowchart illustrating a book scan processing routine in a fourth embodiment.

FIG. 30 is a schematic view illustrating a selection screen displayed in a post-cancellation operation waiting state.

FIG. 31 is a flowchart illustrating a book scan processing routine in a fifth embodiment.

FIG. 32 is a schematic view illustrating a selection screen displayed after a timeout.

FIG. 33 is a schematic view illustrating a selection screen displayed when transitioning to a manual scan mode.

### DESCRIPTION OF EMBODIMENTS

### First Embodiment

Hereinafter, an embodiment of an image reading apparatus will be described with reference to the drawings.

### Configuration of Image Reading Apparatus

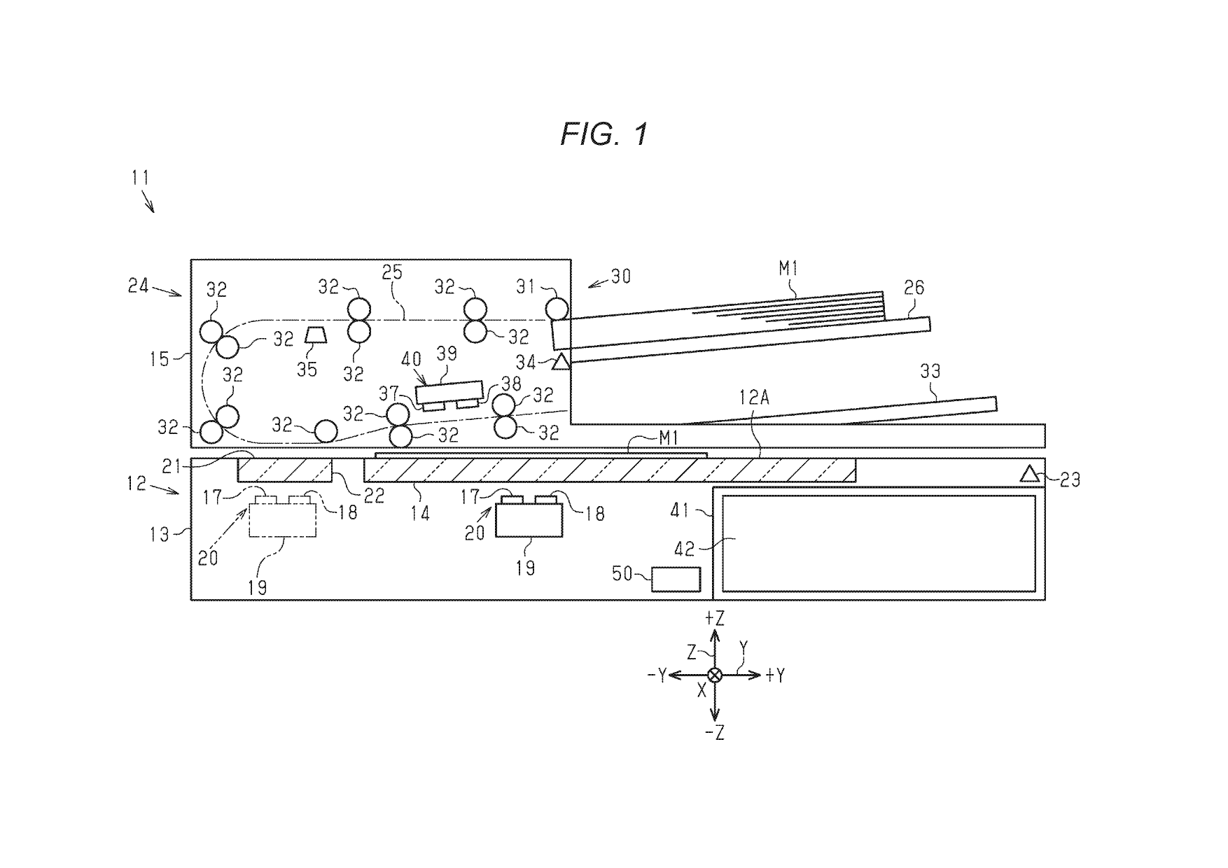

FIG. 1 illustrates an image reading apparatus 11 that is in a posture in a use state. XYZ axes illustrated in FIG. 1 are orthogonal to one another. The Z axis is an axis parallel to the direction of gravity. The Y axis is an axis parallel to a width direction of the image reading apparatus 11 when viewed from the front illustrated in FIG. 1. The X axis is an axis parallel to a depth direction of the image reading apparatus 11. Directions parallel to the X axis, the Y axis, and the Z axis are respectively represented as an X direction, a Y direction, and a Z direction. The X direction includes both of a +X direction and a -X direction. The Y direction includes both of a +Y direction and a -Y direction. The Z direction includes both of a +Z direction and a -Z direction. The Y direction is also referred to as the width direction Y, the X direction is also referred to as a depth direction X, and the Z direction is also referred to as a vertical direction Z.

As illustrated in FIG. 1, the image reading apparatus 11 includes a document table 12 and a document cover 15. The document table 12 has a placement surface 12A on which a document M1 is placed. The document M1 is set on the document table 12 by being placed on the placement surface 12A.

The document table 12 includes a housing 13 and a transparent plate 14. The transparent plate 14 is attached to an upper part of the housing 13. The transparent plate 14 forms a top plate of the housing 13. The document table 12 has translucency. That is, the document table 12 has translucency at a portion of the transparent plate 14. The upper surface of the transparent plate 14 forms the placement surface 12A. The document table 12 has translucency on the placement surface 12A. The upper surface of a portion where the transparent plate 14 is exposed on the upper surface of the document table 12 is the placement surface 12A. The placement surface 12A has a size for enabling the document M1 having the largest size readable by the image reading apparatus 11 to be placed.

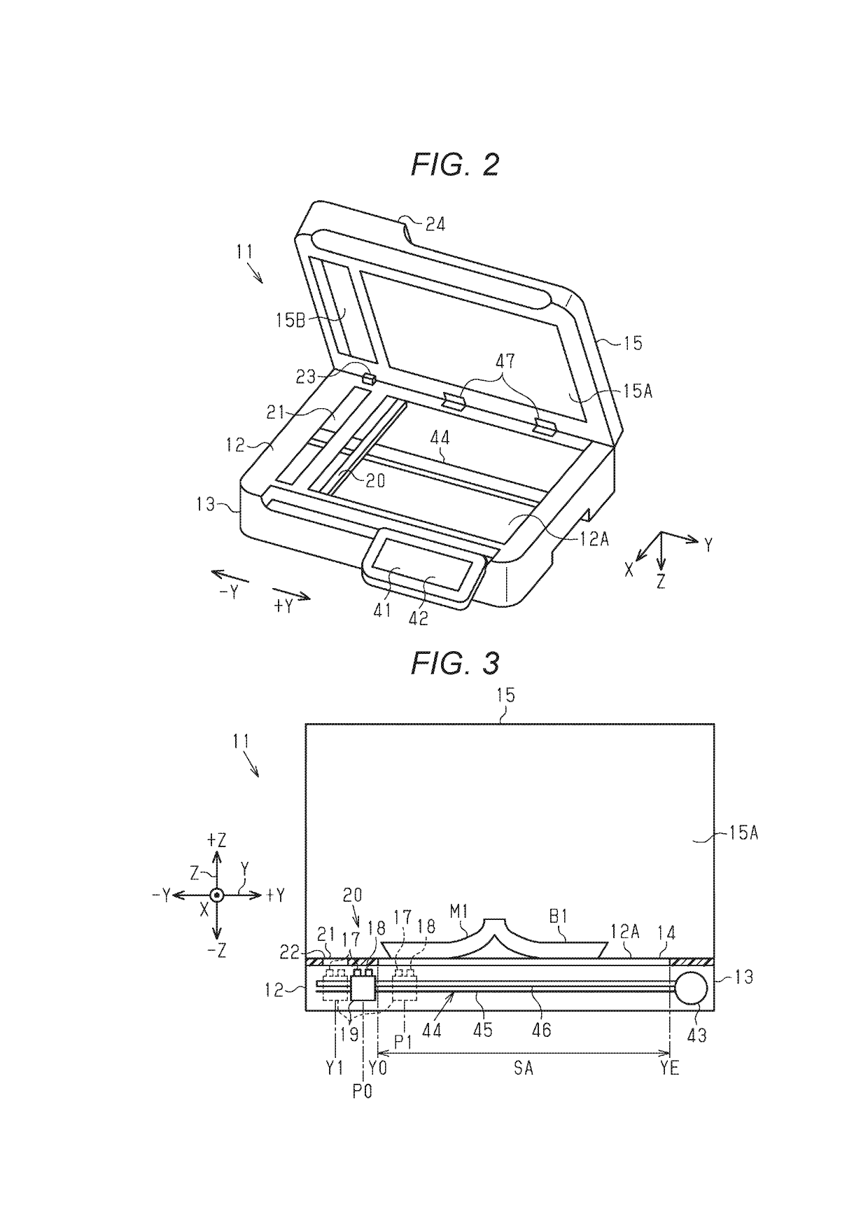

The document cover 15 opens and closes the placement surface 12A of the document table 12. The document cover 15 is implemented to be pivotable with respect to the document table 12. The document cover 15 is attached to the document table 12 via a hinge mechanism 47 (see FIG. 2). In the front view illustrated in FIG. 1, a pivot axis of the document cover 15 extends in the width direction Y at a position on a back side in the depth direction X. The document cover 15 can be opened and closed within a range of a predetermined angle centering on the pivot axis on the back side.

When the document cover 15 is opened with respect to the document table 12, the placement surface 12A, which is the upper surface of the transparent plate 14, is exposed. Accordingly, a user can place (set) the document M1 on the placement surface 12A. The document cover 15 presses the document M1 placed on the placement surface 12A from above by being closed with respect to the document table 12. In the closed state illustrated in FIG. 1, the document M1 placed on the placement surface 12A is pressed against the placement surface 12A by the document cover 15 in the closed state. In a normal mode, the document M1 is read by the image reading apparatus 11 in this pressed state. The image reading apparatus 11 according to the present embodiment has a book scan mode, which is an example of a mode in which reading of the document M1 is executed in an open state in which the document cover 15 is opened. The book scan mode will be described later.

The image reading apparatus 11 includes a reading unit 17 and a light emitting unit 18. The reading unit 17 is implemented to read the document M1 placed on the placement surface 12A. The reading unit 17 reads, on the side opposite to the placement surface 12A, the document M1 placed on the placement surface 12A of the document table 12. The reading unit 17 is located in the housing 13 of the document table 12. The reading unit 17 is located on the side opposite to the placement surface 12A with the transparent plate 14 interposed therebetween. The reading unit 17 is implemented to scan in the housing 13.

As illustrated in FIG. 1, the image reading apparatus 11 may include a carriage 19 that supports the reading unit 17 and the light emitting unit 18. The carriage 19 that supports the reading unit 17 is implemented to be movable in the width direction Y. The reading unit 17 is implemented to move along the placement surface 12A in the width direction Y together with the carriage 19 in a state of facing the placement surface 12A on the transparent plate 14. The reading unit 17 scans the document M1 placed on the placement surface 12A to thereby read the document M1 through the transparent plate 14. The reading unit 17 is movable over a range wider than the placement surface 12A in the width direction Y.

The reading unit 17 includes, for example, a line sensor having an elongated shape in one direction. In the example illustrated in FIG. 1, the reading unit 17 is disposed in a direction in which the longitudinal direction thereof is parallel to the depth direction X. The longitudinal direction of the reading unit 17 is referred to as a main scanning direction, and a moving direction of the reading unit 17 is referred to as a sub scanning direction. Since the main scanning direction is a direction parallel to the depth direction X, the main scanning direction is also referred to as a "main scanning direction X". Since the sub scanning direction is a direction parallel to the width direction Y, the sub scanning direction is also referred to as a "sub scanning direction Y". The main scanning direction X and the sub scanning direction Y intersect (for example, are orthogonal to) each other. The reading unit 17 is movable in a first direction +Y and a second direction -Y in the sub scanning direction Y by the movement of the carriage 19.

The light emitting unit 18 is capable of switching turning-on and turning-off. The light emitting unit 18 is located in the housing 13 of the document table 12. The light emitting unit 18 is provided on a side opposite to the placement surface 12A of the document table 12. The light emitting unit 18 can emit light to the outside of the placement surface 12A from the side opposite to the document table 12. The light emitting unit 18 illuminates the document M1 by being turned on when the reading unit 17 reads the document M1. The light emitting unit 18 illuminates the document M1 from the side opposite to the placement surface 12A of the document table 12 in a turn-on state. The light emitting unit 18 illuminates a reading target region to be read by the reading unit 17 on a reading surface of the document M1 placed on the placement surface 12A.

The light emitting unit 18 is implemented to scan in the housing 13. The light emitting unit 18 illuminates, through the transparent plate 14, the document M1 placed on the placement surface 12A of the document table 12. The light emitting unit 18 is supported by an upper part of the carriage 19 to move along the placement surface 12A of the document table 12 together with the reading unit 17. The light emitting unit 18 moves in the sub scanning direction Y when the carriage 19 moves. The reading unit 17 and the light emitting unit 18 are supported by the carriage 19 in a state of satisfying a positional relationship in which the light emitting unit 18 can illuminate the reading target region of the reading unit 17. The light emitting unit 18 illuminates the reading target region which is a region extending along the main scanning direction X of the reading unit 17 by being turned on.

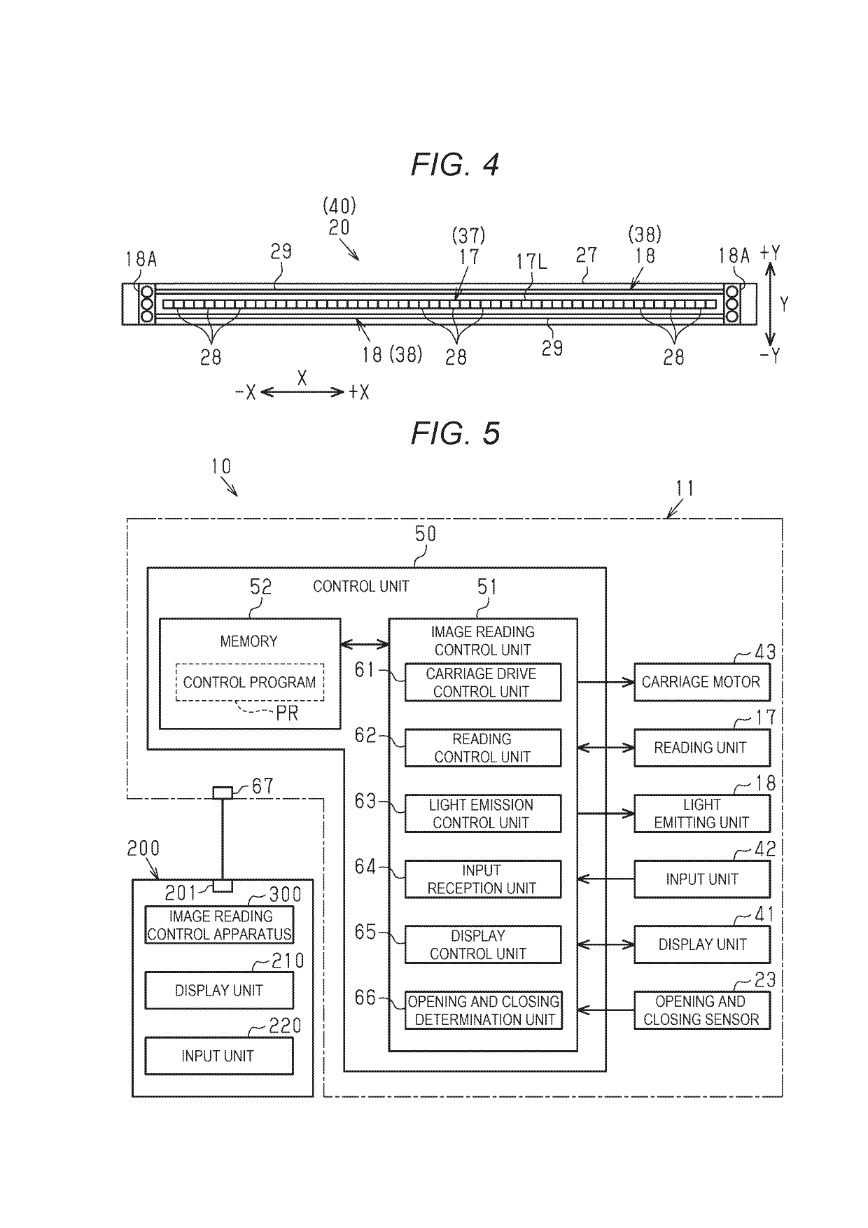

The reading unit 17 and the light emitting unit 18 constitute a reading module 20 (see FIG. 4 as well). The reading module 20 is supported by an upper part of the carriage 19. The reading unit 17 constitutes, for example, a contact image sensor (CIS). The reading module 20 according to the present embodiment is a contact image sensor module (CISM) of a CIS type (contact optical type). A detailed configuration of the reading module 20 will be described later.

The image reading apparatus 11 may include a reading window portion 21. The reading window portion 21 may be located outside the placement surface 12A in a plan view (see FIG. 2 as well). In the example illustrated in FIG. 1, the reading window portion 21 is located outside the placement surface 12A in the sub scanning direction Y. The reading window portion 21 may be provided at a position that the reading unit 17 can face. The reading window portion 21 is disposed at a position adjacent to the transparent plate 14 in the sub scanning direction Y in an upper part of the document table 12. The reading window portion 21 and the transparent plate 14 are respectively attached to positions that are both in a parallel state with and at substantially the same height as the upper part of the housing 13.

The reading unit 17 is implemented to be movable to a position illustrated by a two-dot chain line in FIG. 1, facing the reading window portion 21, by the movement of the carriage 19. The carriage 19 is movable in the sub scanning direction Y over a movement range including a position where the reading unit 17 faces the reading window portion 21 and a region where the reading unit 17 faces the placement surface 12A. Accordingly, the reading unit 17 can read the document M1 being transported at a position facing the reading window portion 21 and can read the document M1 on the placement surface 12A.

The reading window portion 21 includes a small-sized transparent plate 22 that is sufficiently smaller than the transparent plate 14. The transparent plates 14 and 22 are made of, for example, glass. The transparent plate 14 is made of large glass larger than the transparent plate 22 made of small glass constituting the reading window portion 21. Positions and lengths of the transparent plate 14 and the reading window portion 21 in the main scanning direction X are substantially the same.

The image reading apparatus 11 may include an opening and closing sensor 23. The opening and closing sensor 23 detects opening and closing of the document cover 15. The opening and closing sensor 23 is implemented to be capable of detecting an open state and a closed state of the document cover 15. The opening and closing sensor 23 may detect that the document cover 15 is open with respect to the document table 12 or may detect that the document cover 15 is closed with respect to the document table 12. The opening and closing sensor 23 is attached to, for example, the housing 13 of the document table 12 but may be attached to the document cover 15. The opening and closing sensor 23 may be a contact sensor or a non-contact sensor such as an optical sensor. For example, in the closed state of the document cover 15, the opening and closing sensor 23 may be provided at a position on the back side near the pivot axis of the document cover 15 in the depth direction X of the image reading apparatus 11, or may be provided at a position on a pivot end side of the document cover 15.

The opening and closing sensor 23 may detect an open state at the time when an opening angle, which is an angle formed by the document cover 15 with respect to the placement surface 12A, is equal to or larger than a predetermined angle and a closed state at the time when the opening angle is smaller than the predetermined angle. The predetermined angle is a predetermined value within a range from 0 degrees, which is an angle at the time when the document cover 15 is completely closed with respect to the document table 12, to a largest opening angle. The predetermined angle can be set to an appropriate value and, as an example, may be a predetermined value within a range of 1 degree or more and 30 degrees or less. In the present embodiment, the predetermined angle may be, for example, a predetermined value within a range of 2 degrees or more and 20 degrees or less.

The image reading apparatus 11 includes a display unit 41 that displays information. The display unit 41 is implemented to display a screen. The display unit 41 is, for example, a liquid crystal display. The display unit 41 is attached to, for example, the document table 12. The display unit 41 notifies information related to the image reading apparatus 11 to the user by displaying information on the screen.

The image reading apparatus 11 includes an input unit 42. The input unit 42 is operated by the user. The input unit 42 receives an input from the user. That is, the input unit 42 transmits input information received by being operated by the user to a control unit 50. The input information includes various instructions, selections, setting values, and the like given to the image reading apparatus 11.

The input unit 42 includes, for example, a touch panel of the display unit 41. That is, the image reading apparatus 11 further includes the input unit 42 capable of displaying information and receiving an input by the user. The input unit 42 including a touch panel may include at least one operation button or the like displayed as the image (GUI) on the screen of the display unit 41. The user gives the input information to the image reading apparatus 11 by performing a touch operation on the input unit 42 provided on a screen including the touch panel of the display unit 41. The input unit 42 is not limited to the touch panel, and may be implemented by a mechanical switch such as a button, a lever, or a switch. Further, the input unit 42 may include both the touch panel of the display unit 41 and the mechanical switch.

The image reading apparatus 11 includes the control unit 50. The control unit 50 is implemented to control the image reading apparatus 11. The control unit 50 controls the reading unit 17 and the light emitting unit 18. The control unit 50 controls the movement of the carriage 19 along the placement surface 12A. The control unit 50 controls the display unit 41. The control unit 50 causes the display unit 41 to display various information. The control unit 50 receives the input information from the input unit 42 based on an operation of the input unit 42 (pressing the screen) performed by the user. The control unit 50 controls the image reading apparatus 11 based on input information from the input unit 42.

The image reading apparatus 11 includes an image reading function of a flatbed type (FB type) described above and an image reading function of an automatic document feeder type (ADF type) described below. Hereinafter, a configuration of the image reading function of the ADF type will be described with reference to FIG. 1.

### Configuration of Image Reading Apparatus of ADF Type

The image reading apparatus 11 illustrated in FIG. 1 includes an automatic document feeder 24. The automatic document feeder 24 is implemented to automatically feed the document M1. The automatic document feeder 24 is attached to the document cover 15. The automatic document feeder 24 feeds the document M1 into the document cover 15. A transport path 25 is formed in the document cover 15. The transport path 25 is a path on which the document M1 is transported. The transport path 25 extends in the document cover 15. The document M1 is read by the image reading apparatus 11 in a process of being transported on the transport path 25.

The automatic document feeder 24 includes a supply tray 26. The supply tray 26 is attached to the document cover 15. The supply tray 26 extends from the document cover 15. The supply tray 26 is implemented such that the document M1 is set thereon. The document M1 is placed on the supply tray 26, whereby the document M1 is set on the supply tray 26.

The automatic document feeder 24 includes a transport unit 30. The transport unit 30 is attached to the document cover 15. The transport unit 30 is implemented to transport the document M1. The transport unit 30 transports, along the transport path 25, the document M1 set on the supply tray 26. The transport unit 30 includes one or more (a plurality in the example illustrated in FIG. 1) rollers. The transport unit 30 includes, for example, a pickup roller 31 and one or more transport rollers 32. The pickup roller 31 transports a plurality of documents M1 set on the supply tray 26 one by one. In an example, the pickup roller 31 comes into contact with an uppermost document M1 among the plurality of documents M1 stacked on the supply tray 26, and transports the documents M1 in order starting from the uppermost document M1. The plurality of transport rollers 32 are located along the transport path 25. The plurality of transport rollers 32 transport the document M1 along the transport path 25.

The automatic document feeder 24 includes a discharge tray 33. The discharge tray 33 is implemented to receive the document M1 discharged from the document cover 15. The discharge tray 33 is attached to the document cover 15. The discharge tray 33 receives the read document M1.

The automatic document feeder 24 includes a detection unit 34 that detects the presence or absence of the document M1 set on the supply tray 26. The detection unit 34 may be a contact sensor or a non-contact sensor such as an optical sensor. When the opening and closing sensor 23 detects the closed state of the document cover 15 and the detection unit 34 detects the document M1 placed on the supply tray 26, the control unit 50 prioritizes the reading of the ADF type.

The automatic document feeder 24 may include a double-feeding detection unit 35 that detects double-feeding of the document M1. The double-feeding detection unit 35 detects whether the plurality of documents M1 are transported from the supply tray 26 while overlapping. The double-feeding detection unit 35 may include an ultrasonic sensor. The double-feeding detection unit 35 detects double-feeding, for example, when an attenuation rate of ultrasound transmitted through the document M1 exceeds a threshold.

The image reading apparatus 11 includes a reading unit 37 and a light emitting unit 38. The reading unit 37 and the light emitting unit 38 are supported by a support unit 39. The reading unit 37 and the light emitting unit 38 constitute a reading module 40. The support unit 39 supports the reading module 40 in a posture capable of reading the document M1 transported along the transport path 25. A configuration of the reading module 40 is basically the same as the configuration of the reading module 20 in the document table 12. The transport unit 30, the second reading unit 37, and the light emitting unit 38, which constitute the image reading mechanism of the ADF type, are controlled by the control unit 50.

The reading unit 37 is disposed at a position along the transport path 25 in the document cover 15. The reading unit 37 reads the document M1 transported from the supply tray 26. That is, the reading unit 37 reads the document M1 transported along the transport path 25.

The light emitting unit 38 is capable of switching turning-on and turning-off. The light emitting unit 38 is disposed at a position along the transport path 25. In a turn-on state, the light emitting unit 38 illuminates a region including a portion to be read by the reading unit 37 in the document M1 transported along the transport path 25.

The reading unit 17 and the reading unit 37 are implemented to be capable of reading a front surface and a back surface of the document M1 transported along the transport path 25. The reading unit 17 located in the document table 12 has both of the image reading functions of the FB type and the ADF type. In the present specification, the reading unit 17 in the document table 12 is also referred to as "first reading unit 17" and the reading unit 37 in the automatic document feeder 24 is also referred to as "second reading unit 37".

The first reading unit 17 reads, through the reading window portion 21, a first surface of the document M1 transported along the transport path 25. At this time, the first reading unit 17 does not scan the document M1. The first reading unit 17 reads the first surface of the document M1 through the reading window portion 21 in a state of being located at a window position facing the reading window portion 21. The first surface of the document M1 is, for example, the front surface.

The second reading unit 37 reads a second surface of the document M1 transported along the transport path 25. The second surface of the document M1 is a surface on the side opposite to the first surface. The second surface of the document M1 is, for example, the back surface.

When one side of the document M1 transported along the transport path 25 is read, the one side of the document M1 is read by the first reading unit 17. When both sides of the document M1 transported along the transport path 25 are read, both sides of the document M1 are read by the first reading unit 17 and the second reading unit 37. That is, the first reading unit 17 reads the first surface (for example, the front surface) of the document M1 through the reading window portion 21 and the second reading unit 37 reads the second surface (for example, the back surface) of the document M1.

FIG. 2 illustrates the image reading apparatus 11 in an open state in which the document cover 15 is opened. The document cover 15 is pivotably attached to the document table 12 via the hinge mechanism 47. When reading the document M1 using the flatbed type (FB type), the user places the document M1 on the placement surface 12A with the document cover 15 in the open state. The display unit 41 is disposed, for example, on the front side of the document table 12. The user can confirm a display content of the display unit 41 or operate the input unit 42 while performing an operation of placing the document M1 on the placement surface 12A or an operation of aligning the placed document M1.

As illustrated in FIG. 2, a background plate 15A and a transport path 15B are provided on the back surface of the document cover 15. The background plate 15A is disposed at a position corresponding to the placement surface 12A, and has substantially the same shape and size as the placement surface 12A. When the document cover 15 is in the closed state, the placement surface 12A is covered by the background plate 15A. The transport path 15B is disposed at a position corresponding to the reading window portion 21. When the document cover 15 is in the closed state, the reading module 20 can read the first surface (front surface) of the document M1 passing through the transport path 15B by the transport unit 30 via the reading window portion 21. The user can select one of one side and both sides as a reading surface of the document on a setting screen (not illustrated) for setting a reading condition. When double-sided reading is designated, the reading module 20 reads the first surface (front surface) of the document M1 passing through the transport path 15B via the reading window portion 21, and the reading module 40 reads the second surface (back surface) opposite to the first surface of the document M1.

### Detailed Configuration of Flatbed Type

Next, a detailed configuration of the flatbed type image reading apparatus 11 will be described with reference to FIGS. 2 and 3. In FIGS. 2 and 3, a part of the configuration of the ADF type including the automatic document feeder 24 is omitted. The document M1 is, for example, a thick document such as a book or a booklet. FIG. 3 illustrates a state in which a book B1 in an opened state of a page to be read is placed on the placement surface 12A. That is, a state in which the user sets the book B1 on the document table 12 in order to read the page of the book B1 is illustrated.

As illustrated in FIG. 2, the document table 12 has, for example, a rectangular shape as a shape in a plan view when viewed from above. A lower surface (back surface) of the document cover 15 has a rectangular shape having substantially the same size as the upper surface of the document table 12. The upper surface of the document table 12 and the lower surface of the document cover 15 have substantially the same shape and size. In the closed state of the document cover 15 illustrated in FIG. 1, the document table 12 and the document cover 15 overlap in the vertical direction Z. That is, in the closed state of the document cover 15, the document cover 15 covers the entire upper surface including the placement surface 12A of the document table 12 and the reading window portion 21.

As illustrated in FIG. 3, for example, when the document M1 such as the book B1 is placed on the placement surface 12A of the document table 12, the document cover 15 is switched to the open state at a predetermined angle. The document M1 is set on the placement surface 12A of the transparent plate 14, for example, in a state of being close to two sides in the back side and on the left.

As illustrated in FIG. 3, the image reading apparatus 11 includes, in the housing 13 of the document table 12, a scanning mechanism 44 that causes the carriage 19 to perform scanning in the sub scanning direction Y and a carriage motor 43 that is a drive source of the carriage 19. The carriage 19 moves in the sub scanning direction Y via the scanning mechanism 44 with a driving force of the carriage motor 43.

The scanning mechanism 44 includes a guide member 45 and a power transmission mechanism 46. The guide member 45 guides the carriage 19 to be movable in the sub scanning direction Y. The power transmission mechanism 46 transmits the driving force of the carriage motor 43 to the carriage 19 as power for the carriage 19 to move in the sub scanning direction Y. When the carriage motor 43 is driven to rotate forward, the carriage 19 moves in a first direction +Y and, when the carriage motor 43 is driven to rotate backward, the carriage 19 moves in a second direction -Y, which is a direction opposite to the first direction +Y. Along with the movement of the carriage 19, the reading unit 17 and the light emitting unit 18 constituting the reading module 20 move in the sub scanning direction Y.

The position of the carriage 19 indicated by the solid line in FIG. 3 is a standby position P0. The standby position P0 is a position where the reading unit 17 faces a light blocking portion between the reading window portion 21 and the transparent plate 14. When the reading module 20 does not perform reading, the carriage 19 stands by at the standby position P0.

When the reading module 20 performs reading using the ADF type, the carriage 19 moves to a first reading position Y1 located at one end portion in the sub scanning direction Y. The first reading position Y1 is a position where the reading unit 17 faces the reading window portion 21 in the sub scanning direction Y.

When performing reading using the flatbed (FB) type, the reading unit 17 moves to a position in a document reading region SA in the sub scanning direction Y. The document reading region SA is a region corresponding to the placement surface 12A. The document reading region SA is a region in a range from a starting end Y0, which is an end on a reading start side of the placement surface 12A in the sub scanning direction Y, to a terminal end YE. The starting end Y0 is, for example, a reading start position of the reading unit 17. The reading unit 17 reads the document M1 such as the book B1 placed on the placement surface 12A by scanning the inside of the document reading region SA in the sub scanning direction Y from the standby position P0 illustrated in FIG. 3. The reading unit 17 starts reading from, for example, a reading start position Y0 in the process of scanning. The reading unit 17 reads the document M1 by receiving reflected light of light emitted from the light emitting unit 18 and reflected by the reading surface of the document M1.

### Regarding Book Scan Mode

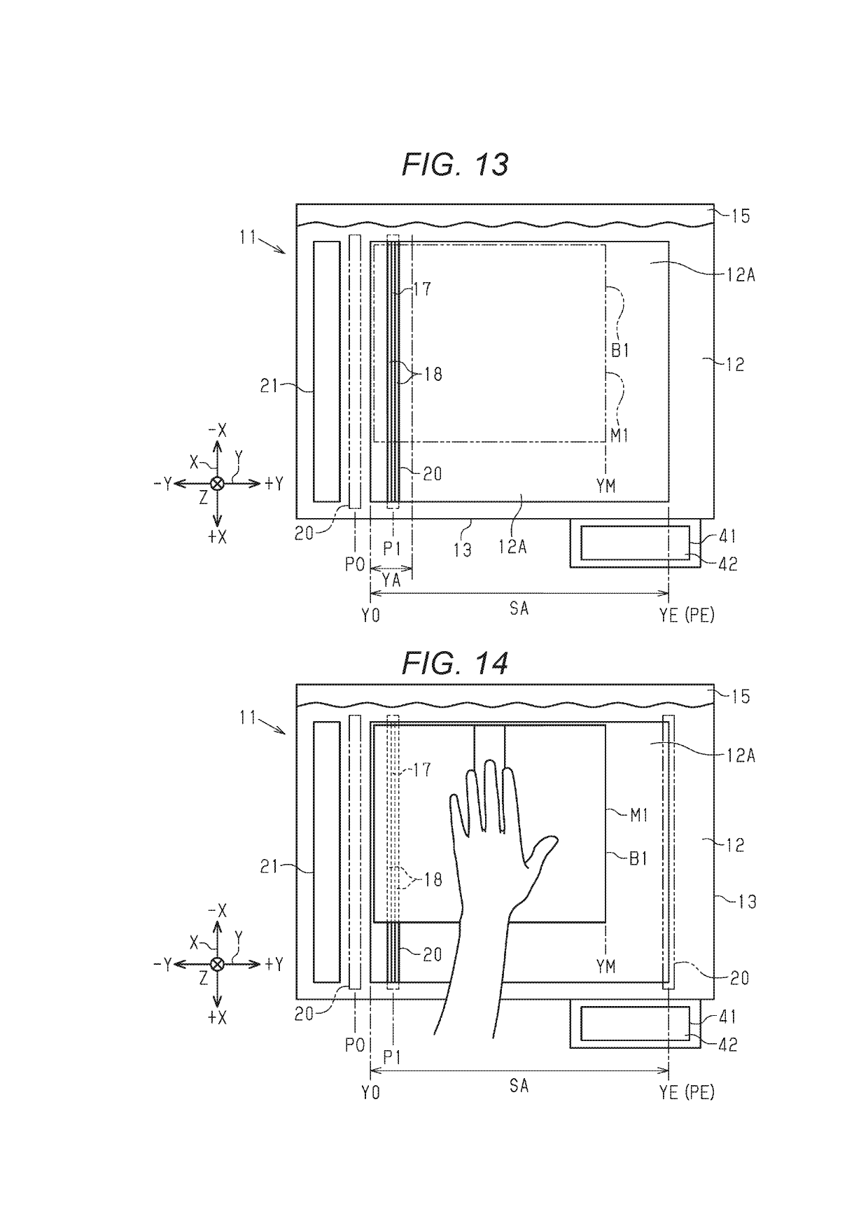

In the image reading apparatus 11, there is a case in which a thick document M1 made of a booklet such as the book B1 is read. For example, in a state in which a page of the book B1 (see FIG. 3) to be read is opened, the user presses the opened page against the placement surface 12A as the reading surface. Since the book B1 is thick, it is difficult to close the document cover 15. When the user presses the document cover 15 to a closing side to press the opened page of the book B1 against the transparent plate 14, a force in an oblique direction is applied from the document cover 15 to the book B1. As a result, a placement position of the book B1 with respect to the placement surface 12A easily deviates. Therefore, the page of the book B1 is read in a state in which the user manually aligns the book B1 and presses the reading surface of the book B1 against the placement surface 12A with the document cover 15 in the open state. When the user is forced to confirm the display content of the display unit 41 or to perform an operation (pressing the screen) via the input unit 42 while holding the book B1 aligned at a predetermined position on the placement surface 12A by hand (see FIG. 13), the user cannot concentrate on the alignment of the book B1. Therefore, when these are forced, it is necessary to direct the line of sight to the display unit 41 or operate the input unit 42 with the other hand, which is likely to hinder a positioning work of the book B1. For example, when the user is forced to perform an operation of starting scanning, it is necessary to perform the operation with the other hand while directing the line of sight to the input unit 42, and thus the position of the book B1 is likely to be deviated during the operation.

Therefore, the image reading apparatus 11 according to the present embodiment has a book scan mode which is a mode in which scanning is automatically started when it is detected that the document M1 such as the book B1 is placed on the placement surface 12A. In the book scan mode, after an operation (job start operation) of starting reading is performed first, when placement of the document M1 is detected in a document detection process of detecting that the document M1 is placed (set) on the placement surface 12A, reading of the document M1 is automatically started.

In the present embodiment, the document M1 assumed to be read in the book scan mode is a booklet such as the book B1. In the present specification, the "booklet" includes the book B1 that is a thick non-periodic publication having a predetermined number of pages or more in the body text. The "booklet" includes a thin pamphlet or booklet whose body text is less than a predetermined page, a leaflet which is a printed matter obtained by folding one sheet into a booklet, and the like. The book scan mode is an example of a mode in which the document M1 is read while the document cover 15 is in the open state, and the document M1 to be read is not limited to a booklet.

### Configuration of Reading Module 20

Next, a configuration of the reading module 20 will be described with reference to FIG. 4. The two reading modules 20 and 40 have the same basic configuration. Therefore, the configuration of the reading module 20 will be described below.

The reading module 20 is, for example, a contact image sensor (CIS). The reading module 20 includes the reading unit 17 and the light emitting unit 18. The reading unit 17 and the light emitting unit 18 constituting the contact image sensor are integrated. The reading module 20 includes a long support unit 27 extending in the main scanning direction X. The reading unit 17 and the light emitting unit 18 are supported by the support unit 27 in a state in which the longitudinal direction of the reading unit 17 and the light emitting unit 18 is arranged in a direction coinciding with the main scanning direction X.

The reading unit 17 illustrated in FIG. 4 includes, for example, a line sensor 17L and an imaging lens (not illustrated). The line sensor 17L includes a plurality of image sensors 28. The plurality of image sensors 28 constituting the line sensor 17L are arranged in a row along the main scanning direction X. The image sensor 28 is a photoelectric conversion element. The image sensor 28 is equivalent to one reading pixel (one pixel) constituting the line sensor 17L. The image sensor 28 outputs a luminance signal corresponding to the amount of received incident light. The number m of the plurality of image sensors 28 is, for example, a predetermined number within a range of 500 to 10,000. An imaging lens is configured with a lens array such as a rod lens array (equal magnification imaging system lens).

The light emitting unit 18 includes light sources 18A and a light guide member 29. One light source 18A is disposed at one end portion or two light sources 18A are disposed at both end portions of the support unit 27 in the longitudinal direction. In the example illustrated in FIG. 4, two light sources 18A are disposed at both the end portions of the support unit 27 in the longitudinal direction. The light guide member 29 is supported by the support unit 27 in a state of extending in the main scanning direction X at a position on both sides or one side of the reading unit 17 in the sub scanning direction Y. In the example illustrated in FIG. 4, a pair of light guide members 29 are disposed on both sides of the reading unit 17 in the sub scanning direction Y. The light guide member 29 is, for example, a light guide. The light guide member 29 illuminates a reading target area of the reading unit 17 while guiding light from the light source 18A in the main scanning direction X when the light source 18A is turned on. The light emitting unit 18 emits uniform light in the main scanning direction X from the light guide member 29 when the light source 18A is turned on. The light source 18A may be a white light source that emits white light or may include three types of light sources capable of respectively emitting monochromatic light of red, green, and blue. The light source 18A may include, for example, a light emitting diode (LED).

### Electrical Configuration of Image Reading Apparatus 11

Next, an electrical configuration of the image reading apparatus 11 according to the present embodiment will be described with reference to FIG. 5. In FIG. 5, a part of the configuration of the ADF type image reading mechanism of the image reading apparatus 11 is omitted.

As illustrated in FIG. 5, the image reading apparatus 11 includes the control unit 50, the carriage motor 43, the reading unit 17, the light emitting unit 18, the input unit 42, the display unit 41, and the opening and closing sensor 23.

The control unit 50 may include one or more processors that execute various processes according to a computer program. The control unit 50 may include one or more dedicated hardware circuits, for example, ASICs that execute at least some processes. The control unit 50 may include a circuit including a combination of a processor and a hardware circuit. The processor includes a CPU and a memory 52 such as a RAM and a ROM. The memory 52 stores program codes or commands implemented to cause the CPU to execute processes. The memory, that is, a computer-readable medium includes any readable medium accessible by a general-purpose or dedicated computer.

The carriage motor 43, the reading unit 17, the light emitting unit 18, the input unit 42, the display unit 41, and the opening and closing sensor 23 are electrically connected to the control unit 50. The control unit 50 controls the carriage motor 43, the reading unit 17, and the light emitting unit 18 to execute various processes related to reading of the document M1 and reading of the document M1.

The control unit 50 includes an image reading control unit 51 and the memory 52. A control program PR is stored in the memory 52. The image reading control unit 51 includes software implemented by a computer of the control unit 50 executing the control program PR and the like and hardware such as an ASIC. The image reading control unit 51 includes a carriage drive control unit 61, a reading control unit 62, a light emission control unit 63, an input reception unit 64, a display control unit 65, and an opening and closing determination unit 66.

The carriage drive control unit 61 controls the carriage motor 43. The carriage drive control unit 61 moves the carriage 19 in the sub scanning direction Y by driving the carriage motor 43 to rotate forward and backward. The control unit 50 causes, with the movement of the carriage 19, the reading unit 17 and the light emitting unit 18 to perform scanning in the sub scanning direction Y.

The reading control unit 62 controls the reading unit 17. The reading control unit 62 controls a reading process of the reading unit 17. The reading unit 17 outputs a read signal formed by an analog signal by reading the document M1. The read signal includes a serial signal having, as a signal value, each light receiving amount of the plurality of image sensors 28 constituting the reading unit 17. The reading control unit 62 generates read data by converting the read signal input from the reading unit 17 from the analog signal into a digital signal. The read data includes serial data in which each light receiving amount of the plurality of image sensors 28 at different main scanning positions is indicated by a tone value of a predetermined tone (for example, 256 tones). The read data includes a plurality of pieces of serial data corresponding to read signals read at each sub scanning position by the reading unit 17 moving in the sub scanning direction Y. The read data is, for example, data of a reading resolution designated by the reading condition. The control unit 50 generates scan data which is a reading result of the document M1 by performing a predetermined process on the read data from the reading control unit 62. The predetermined process may include an image process of at least one of rotation, background removal, shadow removal, tilt correction, and blank page removal of a document image. Further, the predetermined process may include a filing process of generating scan data by filing image data after the image process.

The control unit 50 performs a document detection process of detecting the document M1 placed on the placement surface 12A by the user. Specifically, the reading control unit 62 causes the reading unit 17 to perform reading for document detection at a predetermined position on the placement surface 12A in a document placement waiting state.

The light emission control unit 63 performs control for switching light emission and turn-off of the light emitting unit 18. The control unit 50 turns off the light emitting unit 18 in a standby state in which reading is not executed. The control unit 50 turns on the light emitting unit 18 during reading of the document M1. The control unit 50 performs the document detection process of detecting that the user places the document M1 on the placement surface 12A. The light emission control unit 63 turns on the light emitting unit 18 in the document detection process of detecting the document M1 placed on the placement surface 12A. The turning on of the light emitting unit 18 in the document detection process may be blinking.

The input reception unit 64 receives input information input by the user operating the input unit 42. The input unit 42 according to the present embodiment includes, for example, a touch panel of the display unit 41. The input reception unit 64 receives the input information input via the input unit 42 (touch panel) by the user performing a touch operation on options such as selection items or buttons on the screen displayed on the display unit 41. The input reception unit 64 receives, for example, mode selection information, job start instruction information, mode end instruction information, and various types of setting information as the input information.

The display control unit 65 controls the display unit 41. The display control unit 65 controls the display unit 41 to display screens such as a menu screen and various setting screens on the display unit 41. The screen includes guidance information and notification information. The display control unit 65 causes the display unit 41 to display guidance information for guiding an operation or the like to be performed by the user in the book scan mode and notification information to be notified to the user through a screen displayed on the display unit 41. In a mode in which the user reads the thick document M1 such as the book B1 (book scan mode), the display control unit 65 displays guidance information for the mode on the display unit 41. For example, the display control unit 65 causes the display unit 41 to display various screens D1 to D8 illustrated in FIGS. 7 to 9, 11, 12, and FIGS. 16 to 18. Details of the various screens D1 to D8 will be described later.

The opening and closing determination unit 66 receives an input of a detection signal from the opening and closing sensor 23. The opening and closing determination unit 66 determines, based on the detection signal input from the opening and closing sensor 23, whether the document cover 15 is in the open state or the closed state. Here, the opening and closing sensor 23 outputs a detection signal when the document cover 15 is in the closed state, and outputs a non-detection signal when the document cover 15 is in the open state. The opening and closing sensor 23 outputs the non-detection signal indicating the open state when an angle of the document cover 15 exceeds a predetermined angle larger than 0 degrees. The opening and closing sensor 23 outputs the detection signal indicating the closed state when the angle of the document cover 15 is smaller than the predetermined angle.

### Image Reading Control Apparatus (Host Apparatus)

The image reading apparatus 11 can be communicably connected to a host apparatus 200 such as a personal computer (PC). The image reading apparatus 11 and an image reading control apparatus 300 constitute an image reading system 10. The image reading apparatus 11 includes a communication interface 67 capable of communicating with the host apparatus 200. The host apparatus 200 includes a communication interface 201 capable of communicating with the communication interface 67 of the image reading apparatus 11. The image reading apparatus 11 can perform wired or wireless communication with the host apparatus 200 via the communication interfaces 67 and 201. The host apparatus 200 is not limited to a PC, and may be implemented by, for example, a smartphone, a mobile phone, a tablet PC, or a mobile terminal such as personal digital assistants (PDA).

The host apparatus 200 includes a display unit 210 and an input unit 220. The display unit 210 is, for example, a liquid crystal display. The input unit 220 includes a keyboard, a pointing device such as a mouse, and the like. The host apparatus 200 includes a CPU and a memory. The memory stores a scan driver program. For example, the scan driver program is installed in the host apparatus 200 from a storage medium such as a CD-ROM or a DVD, or is downloaded to the host apparatus 200 through the Internet from a predetermined server provided by an image reading apparatus manufacturer or the like. The image reading control apparatus 300 includes software constructed in the host apparatus 200 by the CPU of the host apparatus 200 executing a scan driver program. The image reading control apparatus 300 includes a scan driver.

The user can give an instruction to the image reading control apparatus 300 by operating the input unit 220. For example, the user can set a reading condition by pressing various buttons on the setting screen displayed on the display unit 210 by operating the input unit 220. The user can give a reading instruction (scan instruction) to the image reading control apparatus 300 by pressing a job start button on the setting screen. Upon receiving the reading instruction, the image reading control apparatus 300 generates a reading job based on the reading conditions. The image reading control apparatus 300 transmits the generated reading job to the image reading apparatus 11.

The image reading control apparatus 300 (scan driver) can cause the display unit 210 of the host apparatus 200 to display guidance information and notification information having the same contents as those of various types of guidance information and notification information displayed on the display unit 41 of the image reading apparatus 11. That is, the image reading control apparatus 300 includes a GUI similar to the GUI on an image reading apparatus 11 side. By operating the input unit 220 of the host apparatus 200, the user can give various instructions related to the book scan mode to the image reading control apparatus 300 by selection of the book scan mode, an operation of the job start button, an end operation of the book scan mode, a cancel operation, and the like. These operation functions related to the book scan mode may be implemented by a GUI generated by the scan driver. The user can also give various instructions including an instruction to start a reading job to the control unit 50 of the image reading apparatus 11 by operating the input unit 220 of the host apparatus 200.

### Regarding Book Scan Mode

The control unit 50 has a book scan mode as an example of a mode for executing reading of the document M1 in an open state in which the document cover 15 is open with respect to the document table 12. The control unit 50 has a standard scan mode as an example of a mode for executing reading of the document M1 in a closed state in which the document cover 15 is closed with respect to the document table 12. The standard scan mode is, for example, a default mode to be selected when scanning a document or the like printed on a single sheet. When the document is a booklet such as the book B1 and the user wants to read the book B1 in the open state of the document cover 15, the user selects the book scan mode.

FIG. 7 illustrates a selection screen D1 of a document standby mode. The document standby mode is a mode in which the image reading apparatus 11, upon detecting that the document M1 is set, automatically starts reading the document M1. The image reading apparatus 11 according to the present embodiment includes an ADF type document standby mode and an FB type document standby mode. The FB type document standby mode is a mode in which the image reading apparatus 11 automatically starts reading the document M1 when it is detected that the user places (sets) the document M1 such as the book B1 on the placement surface 12A. The FB type document standby mode corresponds to a book scan mode as an example of a mode.

As illustrated in FIG. 7, the selection screen D1 of the document standby mode includes a mode selection button 70 for selecting the book scan mode. In addition to the FB type document standby mode, an ADF type document standby mode may be provided.

The image reading apparatus 11 includes a job start button 71 that receives an instruction to start a reading job of the document M1. In the present embodiment, the job start button 71 is implemented by a graphical user interface (graphical user interface (GUI)). Specifically, the selection screen D1 including the job start button 71 is implemented by the GUI.

The selection screen D1 includes an "automatic mode" in which a reading job of the document M1 is started "automatically" and a "manual mode" in which the reading job is started manually in the book scan mode. In the automatic mode, even when a plurality of documents are read, the start of a reading job may be instructed only once. The selection screen D1 includes the job start button 71 operated by the user when instructing the start of the reading job only for the first time. The selection screen D1 includes a manual mode selection button 72 for selecting a "manual mode" in which a reading job of the document M1 (book B1) is started "manually" for each page. The control unit 50 according to the present embodiment is characterized in that, in the book scan mode in which the document M1 is read under the open state of the document cover 15, the reading job of the document M1 for each page is automatically started based on the detection of the placement of the document M1 on the placement surface 12A. For example, the user can automatically start a reading job for each of the documents M1 such as the book B1 by pressing the mode selection button 70 for selecting the book scan mode on the selection screen D1 and pressing the job start button 71. The selection screen D1 includes a close button 73 for instructing to close the screen from the display unit 41. In the present specification, "press" indicating a button operation includes a touch operation of selecting a button or the like on the screen of the display unit 41 including a touch panel.

### Regarding State Transition of Book Scan Mode

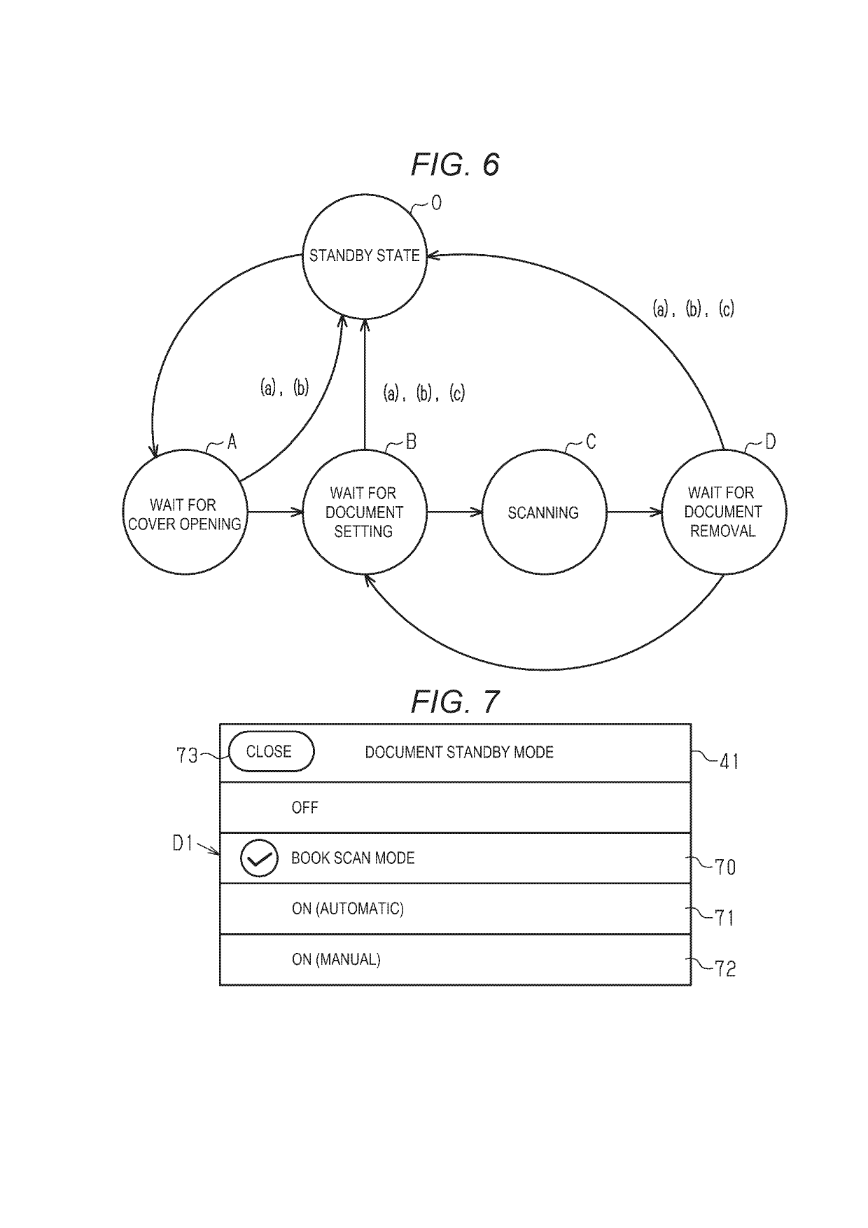

Next, the state transition of the book scan mode will be described with reference to FIG. 6. The image reading apparatus 11 is in a standby state 0 before the book scan mode is selected. When the book scan mode is set, thereafter, a cover open waiting state A, a document setting waiting state B which is an example of a placement waiting state, a scanning state C, and a document removal waiting state D which is an example of a removal waiting state are sequentially transitioned. In the book scan mode, when the user opens the document cover 15 and places the booklet such as the book B1 on the placement surface 12A with the reading surface of the book B1 or the like facing downward, the image reading apparatus 11 automatically detects the placement of the book B1, thereby automatically starting reading of the book B1. Every time the page is changed and the book B1 is placed on the placement surface 12A, the image reading apparatus 11 that detects the placement of the book B1 automatically starts reading the book B1. In this way, the user can automatically proceed with the reading of the book B1 without pressing a start button or the like only by performing the operation of placing the book B1 with the changed page on the placement surface 12A. In the book scan mode, operations performed by the user in the process of reading a plurality of pages of the book B1 include a document cover opening operation, a document setting operation (document placing operation), and a document removing operation. The document cover opening operation is an operation of opening the document cover 15 to be in the open state. The document setting operation is an operation of setting (placing) the book B1 on the placement surface 12A. The document removing operation is an operation of removing, from the placement surface 12A, the book B1 whose page has been read (scanned). After the document removing operation, when there is a page to be read, the page to be read is changed to the next page to be read, and then the book B1 is set on the placement surface 12A.

When the book scan mode is selected as an example of a mode in which reading of a plurality of documents M1 is continuously performed for each of the documents M1 in the open state in which the document cover 15 is opened with respect to the document table 12, the control unit 50 shifts to any of the following three waiting states A, B, and D.

The document cover open waiting state A for waiting for the open state of the document cover 15.

The placement waiting state B in which the document M1 is placed on the document table 12.

The removal waiting state D in which the document M1 for which reading is ended is to be removed from the document table 12.

The "cover open waiting state A" illustrated in FIG. 6 is a state in which the image reading apparatus 11 waits for the document cover opening operation by the user. The "document setting waiting state B" is a state of waiting for the document setting operation by the user. The "scanning state C" is a state in which the image reading apparatus 11 is scanning. The "document removal waiting state D" is a state of waiting for a document removing operation by the user.

In the book scan mode, the "standby state 0" transitions to the "cover open waiting state A". The user performs the document cover opening operation. When the opening and closing sensor 23 detects the open state of the document cover 15, the "cover open waiting state A" transitions to the "document setting waiting state B". In the "document setting waiting state B", the image reading apparatus 11 performs the document detection process of detecting whether the document M1 is set (placed) on the placement surface 12A. Details of the document detection process will be described later. When the document M1 is detected by the document detection process, the document setting waiting state B transitions to the scanning state C. Although not illustrated in FIG. 6, when a cancel button 83 is pressed in the scanning state C, the control unit 50 cancels the scanning being executed. When a cancellation process is completed, the control unit 50 transitions from the "scanning state C" to the "document removal waiting state D".

The "scanning state C" refers to a state over a period from a time point when it is detected that the document M1 is set on the placement surface 12A to a time point when the scanning is ended. In the present embodiment, a standby time T1 is set from a document detection time point to the start of a document reading process (scanning process) of reading the document M1. The "scanning state C" also includes a standby state of waiting for a lapse of the standby time T1 before the document reading process is started. That is, the "scanning state C" includes a pre-scan standby state from the document detection time point to a scan start time point, and a scan execution state in which scanning is started after the standby time T1 elapses is being executed. When the scanning of the document M1, that is, the document reading process ends, the state transitions from the "scanning state C" to the "document removal waiting state D".

The "document removal waiting state D" is a state in which the document removing operation of removing the document M1 from the placement surface 12A by the user is waited. After the document reading process (scanning process) ends, the control unit 50 waits until the document M1 is removed from the placement surface 12A by the document removing operation performed by the user. After the end of the document reading process, the control unit 50 performs a document detection process to detect removal of the document M1. The document detection process is basically the same as the document detection process executed in the document setting waiting state B. Both of the document detection processes use the reading unit 17 to cause the reading unit 17 to detect the presence or absence of the document M1 on the placement surface 12A. When the removal of the document M1 from the placement surface 12A is detected by the document detection process, the state transitions from the document removal waiting state D to the document setting waiting state B. However, when a predetermined condition to be described later is satisfied in the document removal waiting state D, the control unit 50 ends the book scan mode. The predetermined condition which is a mode end condition will be described later.

When the document M1 is removed from the placement surface 12A after the end of scanning, the state returns from the document removal waiting state D to the document setting waiting state B again. Accordingly, the second page of the book B1 can be read. In the document setting waiting state B, the control unit 50 waits until the user places the book B1 in which the page to be read is changed to the next page on the placement surface 12A while executing the document detection process. As described above, by repeating the setting and removal of the book B1 whose page is changed by the user, the image reading apparatus 11 transitions to the cycle of the document setting waiting state B to the scanning state C to the document removal waiting state D to the document setting waiting state B, and thus reading of a plurality of pages of the book B1 is automatically performed. That is, the user can cause the image reading apparatus 11 to read a plurality of pages of the book B1 without performing a special instruction operation by simply instructing the book scan mode (automatic) and then repeatedly setting the book B1 on the placement surface 12A while changing the pages of the book B1.

The image reading apparatus 11 includes the cancel button 83 (see FIG. 16), which will be described later, with which the user can give the control unit 50 an instruction to cancel reading (scanning) of the document M1. The cancel button 83 is provided, for example, on a notification screen D6 implemented by a GUI displayed on the display unit 41 in the scanning state C. When the reading (scanning) of the document M1 is canceled by the user, the control unit 50 shifts to the removal waiting state D. That is, the control unit 50 shifts from the scanning state C to the document removal waiting state D both when the reading of the document M1 is ended and when the reading of the document M1 is canceled.

### Start Condition for Reading Job in Book Scan Mode

Next, a start condition for a reading job in the book scan mode will be described. The control unit 50 receives an instruction to start the reading job via the job start button 71. Further, the control unit 50 determines whether the open state is detected by the opening and closing sensor 23. The control unit 50 determines whether the placement of the document M1 on the placement surface 12A is detected. The control unit 50 executes the document detection process to detect that the document M1 is placed on the placement surface 12A. The document detection process is a process of causing the reading unit 17 to execute a reading process for document detection at a predetermined position on the placement surface 12A. The control unit 50 detects that the document is placed on the document table 12 based on a reading result of the reading unit 17. The control unit 50 executes a document reading process of reading the document M1 after the standby time T1 elapses from the detection of the placement of the document M1 on the document table 12 based on the reading result by the reading unit 17.

That is, in the book scan mode, the control unit 50 executes the document reading process of reading the document M1 (book B1) based on the elapse of the standby time T1 from a time point when the following three conditions (a1) to (c1) are satisfied.

(a1) The start of the reading job is instructed by the user.

(b1) The document cover 15 is in the open state.

(c1) The document M1 is placed on the placement surface 12A of the document table 12 (document setting).

Any of (a1) to (c1) may be performed first or later. That is, the order is not limited as long as these three conditions are satisfied.

The (a1) indicates that a job start instruction based on pressing of the job start button 71 by the user is received in the standby state 0. That is, one of the job start conditions is that the image reading apparatus 11 is in the cover open waiting state A by receiving the job start instruction.

The (b1) indicates a cover open state in which the opening and closing sensor 23 detects that the user performs the cover opening operation in the cover open waiting state A. That is, one of the job start conditions is that the image reading apparatus 11 is in the document setting waiting state B by detecting the cover open state.

The (c1) indicates that the document M1 set on the placement surface 12A based on the document setting operation performed by the user is detected in the document setting waiting state B. That is, one of the job start conditions is that the image reading apparatus 11 is in the scanning state C by detecting the document M1 set on the placement surface 12A.

As described above, the job start condition includes three states of transition from the (a1) standby state 0 to the cover open waiting state A, transition from the (b1) cover open waiting state A to the document setting waiting state B, and transition from the (c1) document setting waiting state B to the scanning state C.

Here, the job start instruction includes selection of the book scan mode by pressing the mode selection button 70, and a job start instruction by pressing the job start button 71 in the automatic mode or pressing a job start button (not illustrated) in the manual mode.

In the book scan mode, the document reading process of reading the document M1 is started when the standby time T1 elapses after all of the three conditions (a1) to (c1) are satisfied.

In the book scan mode, a reading start trigger is partially different between the automatic mode and the manual mode. That is, when the book B1 is continuously read page by page, the reading start trigger of the first time (first page) of the book B1 is the same, but the reading start trigger of the document M1 after the second time (second page) is different.

In the automatic mode of the book scan mode, the job start instruction based on the pressing of the job start button 71 may be issued only once at the start of the book scan mode. In this respect, it can be said that the job start button 71 is an automatic mode start button of the book scan mode. The control unit 50 executes the document reading process of causing the reading unit 17 to read the document M1 based on detecting that the document M1 is placed on the placement surface 12A. When the control unit 50 detects that the document M1 is placed on the placement surface 12A in the placement waiting state in the book scan mode, the control unit 50 executes the document reading process. After the job start instruction (automatic mode start instruction) is received, the document reading process is executed when the standby time T1 elapses every time the above-described two conditions (b1) and (c1) are satisfied. That is, after receiving the job start instruction, the control unit 50 starts reading the document M1 for each page when the standby time T1 elapses after the placement of the document M1 on the placement surface 12A is detected (condition (c1) is satisfied) under the open state of the document cover 15 (condition (b1)).

In contrast, in the manual mode of the book scan mode, for each page of the book B1 to be read, when the standby time T1 elapses after all of the above three conditions (a1) to (c1) are satisfied, reading of the document M1 starts for each page. The manual mode is a mode in which the job start instruction is issued by pressing the job start button 71 for each page from which the book B1 is read. In the manual mode, the document reading process is not started until the user presses the job start button 71. The manual mode is a mode in which the user can secure an operation required time required for placing and positioning the book B1 at his or her own pace. In the normal mode, reading of the document M1 is started for each page based on pressing of a job start button (not illustrated) in the closed state of the document cover 15.

### Regarding End Condition for Book Scan Mode

Next, a predetermined condition which is an end condition for the book scan mode will be described with reference to FIG. 6. The control unit 50 receives a selection of a book scan mode which is an example of a mode in which reading of a plurality of documents M1 is continuously performed for each of the documents M1 in an open state in which the document cover 15 is opened with respect to the document table 12. When the book scan mode is selected, the control unit 50 ends the book scan mode, which is an example of the mode, based on a predetermined condition being satisfied in a removal waiting state in which the document M1 for which reading is ended is to be removed from the document table 12.

The predetermined condition is a condition other than an error of the image reading apparatus 11. The predetermined condition other than the error includes the following conditions (a) to (c).

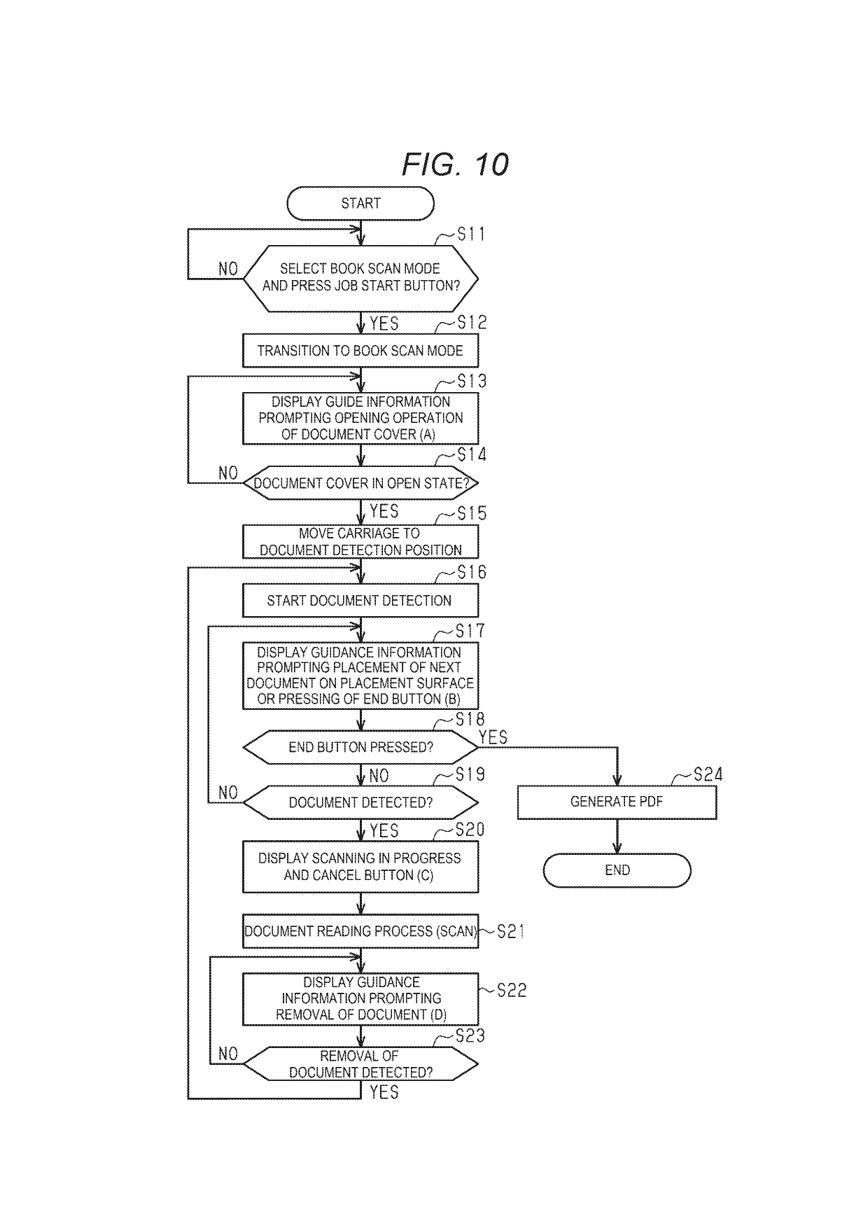

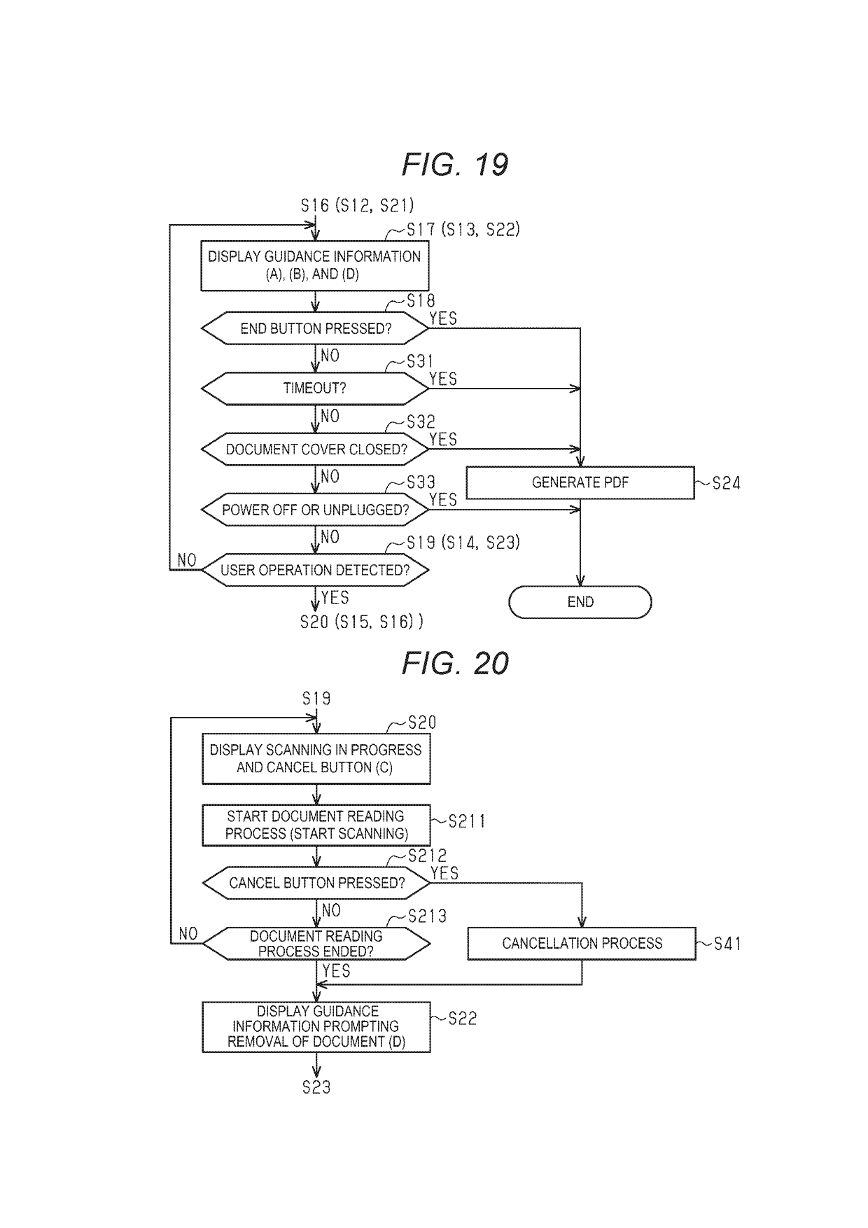

(a) An instruction to end the mode is received (step S18 in FIGS. 10 and 19). (b) A timeout after a predetermined time T2 elapses is satisfied (step S31 in FIG. 19). (c) The document cover 15 is closed (step S32 in FIG. 19).

That is, the predetermined condition includes, as one predetermined condition (a), an instruction to end the mode by the user. In the document removal waiting state D, the control unit 50 ends the mode based on an instruction to end the mode issued by the user. The predetermined condition includes, as one predetermined condition (b), that the predetermined time T2 elapses in the removal waiting state. Further, the predetermined condition includes, as one predetermined condition (c), that the opening and closing sensor 23 detects the closed state of the document cover 15 in the removal waiting state.

The control unit 50 ends the book scan mode when any one of the predetermined conditions (a) to (c) is satisfied. That is, the control unit 50 ends the book scan mode based on one of the predetermined conditions (a) to (c) that is satisfied earliest. One of the mode end conditions other than the predetermined condition is a power supply system error. For example, when the control unit 50 detects that the image reading apparatus 11 is turned off or unplugged even though the image reading apparatus 11 is in the book scan mode, the book scan mode is ended due to a power supply system error (step S33 in FIG. 19).

The control unit 50 may end the book scan mode when any one of the predetermined conditions (a) to (c) is satisfied even in the waiting states A and B other than the document removal waiting state D. In the present embodiment, even in the cover open waiting state A and the document setting waiting state B, the control unit 50 ends the book scan mode based on any one of the predetermined conditions (a) to (c) being satisfied.

That is, as illustrated in FIG. 6, when any one of the predetermined conditions (a) and (b) is satisfied in the cover open waiting state A, the control unit 50 transitions from the cover open waiting state A to the standby state 0 by the end of the book scan mode. When any one of the predetermined conditions (a) to (c) is satisfied in the document setting waiting state B, the control unit 50 shifts from the document setting waiting state B to the standby state 0 by the end of the book scan mode.

In the predetermined condition (b) related to the timeout, the predetermined time T2 which is a set time of the timeout is set. The predetermined time T2 is set to, for example, a predetermined time (second) within a range of 5 to 60 seconds. The predetermined time T2 may be a value exceeding 0 seconds and less than 5 seconds or a value exceeding 60 seconds. The predetermined time T2 may be equal to or less than a time that can secure a time required for an operation to be performed by the user in the waiting state at that time (user operation) and can be clearly regarded as the user ending the reading. The predetermined time T2 may be set to, for example, a predetermined time (second) within a range of 10 to 30 seconds. The same time or different times may be set as the predetermined time T2 defining the timeout in each of the waiting states A, B, and D.

The predetermined time T2 that defines the timeout in each of the waiting states A, B, and D may be set to a different time according to the time required for the user operation. For example, as the predetermined time T2 corresponding to the document setting waiting state B, it is necessary to secure a time required for the user to change to the next page. Therefore, the predetermined time T2 corresponding to the document setting waiting state B may be set to be longer than the predetermined time T2 corresponding to the cover open waiting state A and the predetermined time T2 corresponding to the document removal waiting state D.

When none of the predetermined conditions (a) to (c) is satisfied in the waiting states A, B, and D, the control unit 50 continues the book scan mode. After detecting that the document M1 is removed before the predetermined time T2 elapses in the document removal waiting state D, the control unit 50 continues the book scan mode based on detecting that the document M1 is placed (set) on the document table 12. That is, the control unit 50 continues the book scan mode based on detecting that the document M1 is removed before the predetermined time T2 elapses in the document removal waiting state D. In this case, the state shifts from the document removal waiting state D to the document setting waiting state B while continuing the book scan mode. Thereafter, the control unit 50 continues the book scan mode based on detecting that the document M1 is placed (set) on the document table 12 before the predetermined time T2 elapses in the document setting waiting state B. In this case, the state shifts from the document setting waiting state B to the scanning state C while continuing the book scan mode. However, when the predetermined conditions (a) and (c) other than the timeout are satisfied, the control unit 50 ends the book scan mode even before the predetermined time T2 elapses.

### Generation of Scan Data

Next, a filing process of generating a file of scan data after the book scan mode is ended will be described. When the book scan mode ends, the control unit 50 reads image data stored in a predetermined storage area of the memory 52 and performs a predetermined image process. When the control unit 50 ends the mode based on the predetermined condition being satisfied, the control unit 50 performs a filing process of combining the image data for a plurality of pages after the image process into one file in a predetermined file format. The predetermined file format is, for example, a PDF format. When ending the mode based on the predetermined condition being satisfied, the control unit 50 converts the read image data into a PDF.

One of the predetermined conditions is that the control unit 50 receives a mode end instruction based on the user pressing the end button 81. When the end button 81 is pressed, the control unit 50 ends the mode and converts the read image data into a PDF. The user can designate a file format when converting the image data into a file on a setting screen (not illustrated) displayed on the display unit 41 or the display unit 210. The user may be able to select a desired predetermined file format on the setting screen of the image reading apparatus 11.

Upon receiving the display of the setting screen from the input unit 42, the control unit 50 displays the setting screen on the display unit 41. The setting screen is implemented such that one file format can be selected from a plurality of file formats. The setting screen includes options of a plurality of file formats. The plurality of file formats may include a PDF format, a TIFF format, a JPEG format, a BMP format, and the like. The plurality of file formats prepared as options include a predetermined file format in which the image data of a plurality of pages obtained by a plurality of scans can be combined into one file.

When the predetermined file format is selected, the control unit 50 executes a filing process of combining the image data of a plurality of pages into one file. There are two types of PDF formats of a single page and a multi-page. Here, the single page is a format in which a file is generated for each page when a plurality of documents are read. The multi-page is a format in which a plurality of pages are combined into one file.

The single page PDF format (single) is a format in which one PDF file is generated for each page to be read. The multi-page PDF format (multi) is a format in which a plurality of pages to be read are combined into a PDF. By the PDF conversion, one PDF file in which a plurality of pages to be read are combined into one file is generated. Therefore, the PDF format (multi) belongs to the predetermined file format. Here, the page to be read corresponds to one image acquired by one reading. When the document M1 is the book B1, two pages of the spread correspond to one page of the read image. The PDF (multi) format may be set by default.

As the predetermined file format, a file format other than the PDF format may be selectable. As options of the TIFF format, two types of TIFF (single) format and TIFF (multi) format may be prepared. In this case, the predetermined file format may be the multi (TIFF) format. The options prepared on the setting screen may include one of the PDF format (multi) and the TIFF format (multi).

### Regarding Display Content in Book Scan Mode

Next, a display content displayed on the display unit 41 by the control unit 50 in the book scan mode will be described. In the book scan mode, the control unit 50 causes the display unit 41 to display various types of guidance information for guiding an operation to be performed by the user and notification information for notifying the user of necessary information.

The book scan mode includes a display step of displaying guidance information or notification information on the display unit 41, a user operation step in which the user performs an operation guided by the guidance information, and a processing step in which the reading module 20 performs the predetermined process.

In the display step, in the three waiting states A, B, and D illustrated in FIG. 6, the control unit 50 causes the display unit 41 to display the guidance information for guiding the user to perform necessary operations (user operations) corresponding to the waiting states A, B, and D. The guidance information includes three pieces of guidance information corresponding to the waiting states A, B, and D. That is, the guidance information includes first guidance information corresponding to the cover open waiting state A, second guidance information corresponding to the document setting waiting state B, and third guidance information corresponding to the document removal waiting state D.

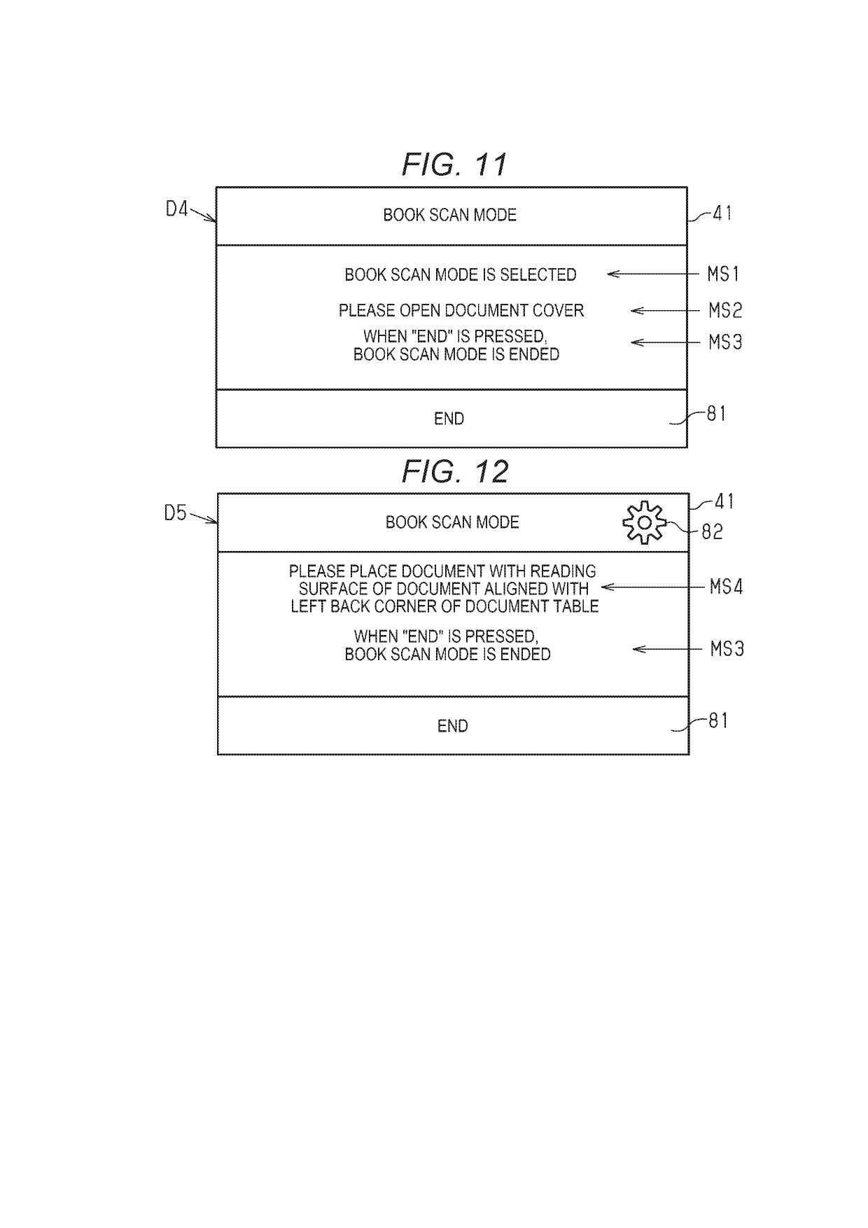

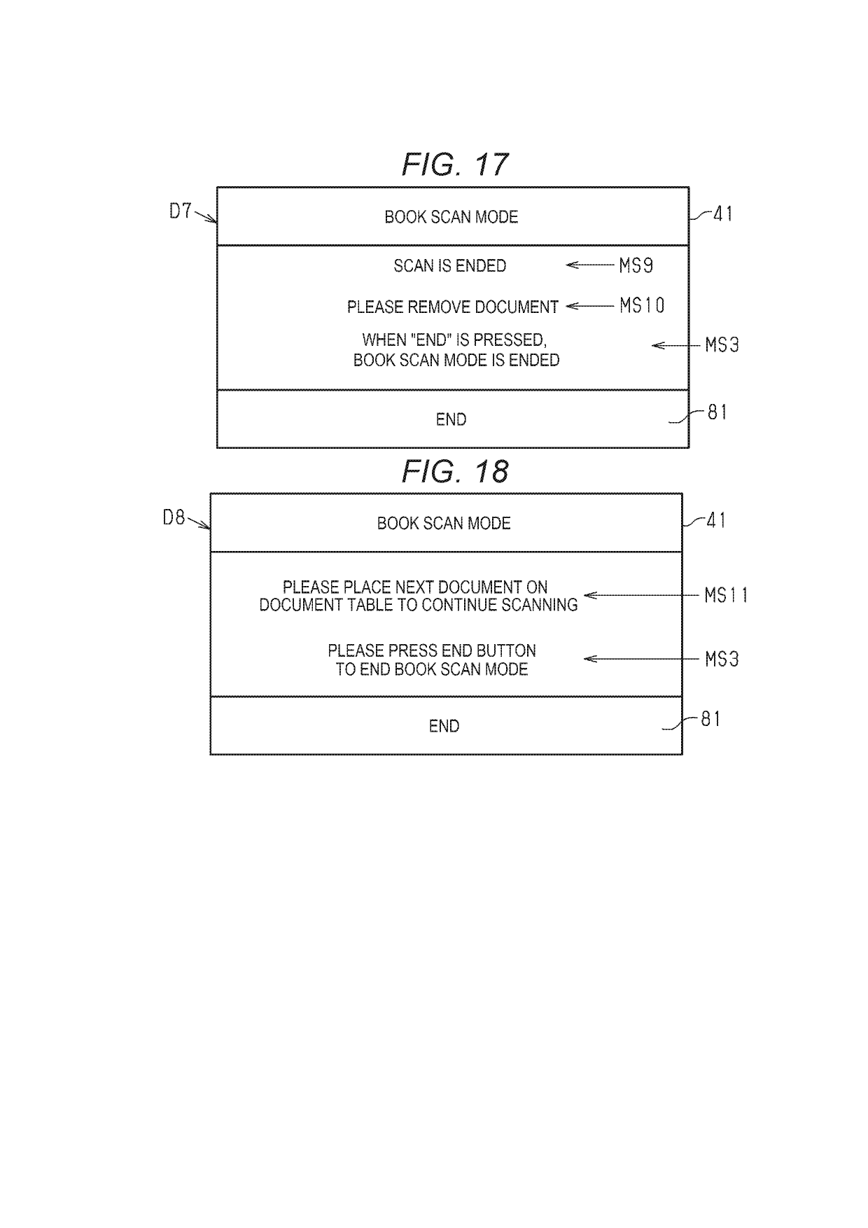

The first guidance information is guidance information (for example, see FIG. 11) that is displayed in the cover open waiting state A and prompts the user to perform the cover opening operation. The second guidance information is guidance information (for example, see FIG. 12) that is displayed in the document setting waiting state B and prompts the user to perform the document setting operation. The third guidance information is guidance information (for example, see FIG. 17) that is displayed in the document removal waiting state D and prompts the user to perform the document removing operation.

In the display step, the control unit 50 causes the display unit 41 to display the notification information for notifying the user of necessary information. The notification information includes state notification information for notifying the user of the state of the image reading apparatus 11. The state notification information includes notification information for notifying that the document is detected, notification information for notifying that the document is in the scanning state C, notification information for notifying that the scanning is ended, and the like. Further, as the notification information related to a numerical value to be notified to the user, the notification information for notifying a waiting time (seconds) until the start of scanning and the notification information for notifying which page is the page to be read of the document M1 are included. When a button provided on the screen displayed on the display unit 41 is pressed, the control unit 50 displays guidance information for guiding what kind of process is to be performed. Examples of such buttons include the end button 81 and the cancel button 83.

In the display step, the control unit 50 displays, as the guidance information or the notification information, various screens D1 and D4 to D11 illustrated in FIGS. 7, 11, 12, 16 to 18, and FIGS. 21 to 23. Details of the screen contents will be described later.

The processing step includes a document detection processing step of detecting that the book B1 is placed at the placement position of the placement surface 12A, and a document reading processing step of reading the book B1 when the placement of the book B1 is detected. The processing step includes a determination processing step of determining whether a predetermined condition for ending the book scan mode is satisfied, and an ending process of ending the book scan mode when the predetermined condition is satisfied. Further, the processing step includes the filing process of combining the image data of one or more pages obtained by reading the book B1 into one file. The filing process is, for example, a PDF conversion process that generates a PDF file by combining the image data of a plurality of pages obtained by reading the document M1. The book scan processing routine illustrated in the flowchart of FIG. 10 includes the above-described steps.

### Regarding Setting of Standby Time T1

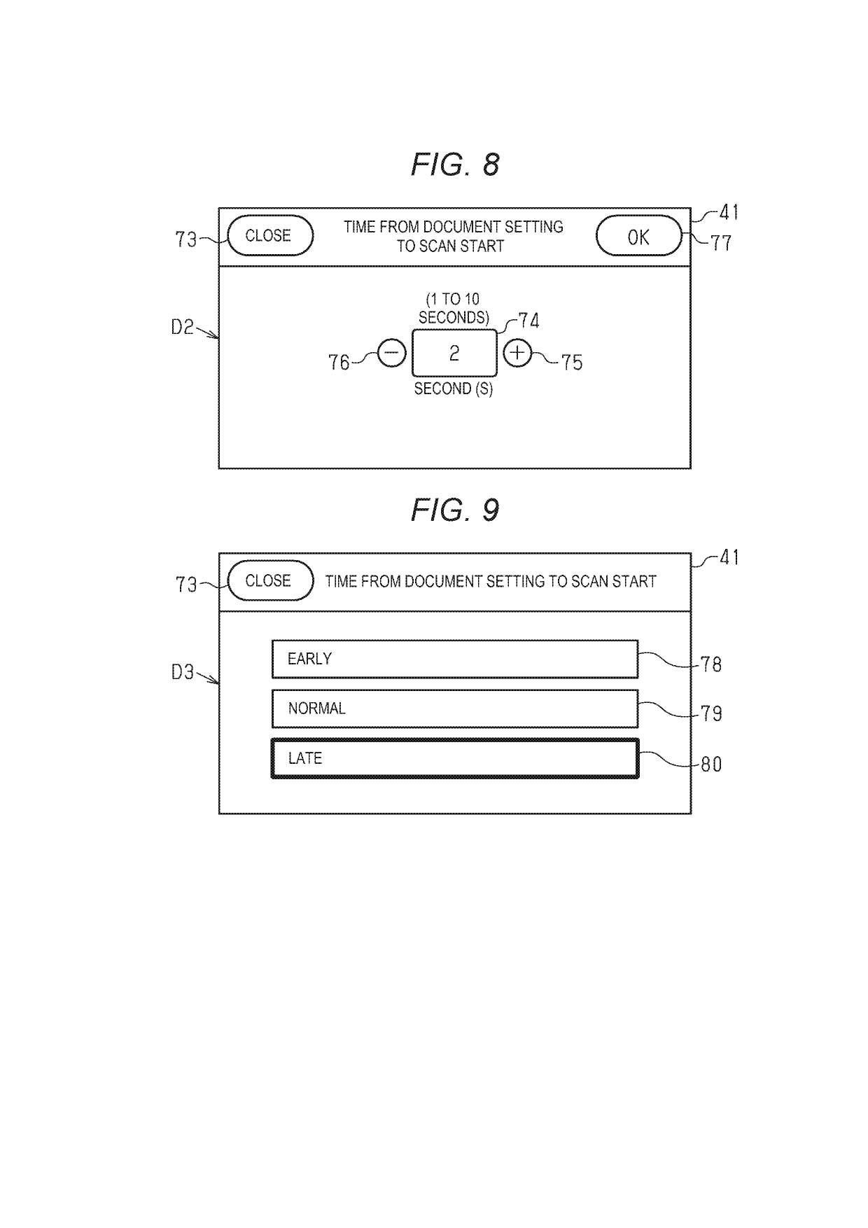

FIGS. 8 and 9 are setting screens D2 and D3 for setting a standby time from document setting to the start of scanning. The control unit 50 has a setting function that allows the user to set a predetermined time as the standby time. In the present embodiment, the first setting screen D2 on which the predetermined time can be set by a numerical value and the second setting screen D3 on which the predetermined time can be set by selecting one of a plurality of options are provided. The control unit 50 causes the display unit 41 to display the setting screens D2 and D3 on which the user can set a predetermined time. One setting screen or a plurality of types of setting screens may be prepared. In the present embodiment, a plurality of types (for example, two types) of setting screens are prepared. That is, in the present embodiment, the first setting screen D2 and the second setting screen D3 are prepared as the setting screens. The first setting screen D2 is a screen on which the predetermined time can be set by a numerical value. The second setting screen D3 is a screen on which the predetermined time can be set by selecting one of a plurality of options obtained by dividing the predetermined time in stages by a length of time.

As illustrated in FIG. 8, the first setting screen D2 includes an input field 74 for inputting the number of seconds, a plus button 75 for increasing the number of seconds of the input field 74, and a minus button 76 for decreasing the number of seconds of the input field 74. Here, a value increased or decreased by one operation of each of the buttons 75 and 76 is not limited to one second, and may be every 0.5 seconds or every two seconds. In addition, when each of the buttons 75 and 76 is continuously pressed, the value may be continuously increased one by one or continuously decreased one by one over a period in which the button is continuously pressed. The first setting screen D2 includes an OK button 77 that is selected when the numerical value of the input field 74 is set as the standby time T1. The user sets the standby time T1 by pressing the OK button 77 after setting the numerical value of the input field 74 to a desired set time. The settable number of seconds is a predetermined time within a range of 1 to 10 seconds, and the settable number of seconds may be set to an appropriate range. For example, a lower limit value of the number of seconds is not limited to 1 second, and may be a shorter number of seconds (for example, 0 second) or a longer number of seconds (for example, 2 seconds). For example, an upper limit value of the number of seconds is not limited to 10 seconds, and may be a shorter number of seconds (for example, 5 seconds) or a longer number of seconds (for example, 15 seconds).

As illustrated in FIG. 9, the second setting screen D3 is a screen on which the predetermined time can be set by selecting one option from among a plurality of options divided in stages by the length of time. The second setting screen D3 includes, as a plurality of options, three options of a first option 78 capable of selecting "early", a second option 79 capable of selecting "normal", and a third option 80 capable of selecting "late". The plurality of options may be two options of "early" and "late", or may be four or more options in which one time can be set as the predetermined time from among four or more time options.

The image reading apparatus 11 according to the present embodiment includes, for example, both the setting screens D2 and D3 of FIGS. 8 and 9. The image reading apparatus 11 may include a selection operation unit (not illustrated) that allows the user to select one of the two setting screens D2 and D3. Similarly to the setting screens D2 and D3, the selection operation unit may be implemented by a GUI that can be displayed on the display unit 41 by the control unit 50. In the image reading apparatus 11 according to the present embodiment, the predetermined time can be set in advance by the setting screens D2 and D3. The standby time T1 may be implemented to be individually set in the automatic mode and the manual mode of the book scan mode.

The memory 52 stores a control program PR including a book scan processing routine illustrated in a flowchart of FIG. 10. The book scan processing routine is a reading control processing routine dedicated to the book scan mode. The book scan processing routine includes a display control program for causing the control unit 50 to display the guidance information on the display unit 41 in the book scan mode. The control program PR includes a program related to a reading control routine (not illustrated) in the normal mode in addition to the book scan mode.

FIG. 11 is a guidance screen D4 displayed on the display unit 41 when the book scan mode and the automatic mode are selected. The guidance screen D4 includes a message MS1 indicating that the book scan mode is selected and a message MS2 prompting the user to open the document cover 15. The guidance screen D4 includes the end button 81 that is pressed when instructing the end of the book scan mode. The guidance screen D4 includes a message MS3 indicating that the book scan mode is ended when the end button 81 is pressed. The user who views the message MS1 opens the document cover 15 in the closed state illustrated in FIG. 1 in the image reading apparatus 11 to bring the document cover 15 into the open state illustrated in FIG. 2. The control unit 50 detects that the document cover 15 is changed from the closed state to the open state based on the detection signal of the opening and closing sensor 23.

FIG. 12 illustrates a guidance screen D5 displayed on the display unit 41 when the user opens the document cover 15 in the book scan mode. The guidance screen D5 includes a message MS4 prompting the user to dispose (place) the document M1 with the reading surface of the document M1 aligned with a left back corner of the document table 12. The message MS4 includes, for example, information such as "please place the document with the reading surface of the document aligned with the left back corner of the document table". A region of the document M1 (book B1) indicated by a two-dot chain line in FIG. 13 is a placement position where the reading surface of the document M1 is to be placed. In a plan view of the placement surface 12A illustrated in FIG. 13, a position at which the reading surface of the document M1 is disposed according to a left back corner (upper left corner in FIG. 13) of the placement surface 12A is a placement position at which the document M1 is to be placed.

When the open state of the document cover 15 illustrated in FIGS. 2 and 13 is detected based on the detection signal of the opening and closing sensor 23, the control unit 50 moves the reading module 20 to a predetermined position indicated by a solid line in FIG. 13 and turns on the light emitting unit 18. Specifically, in FIG. 13, a position in a region between the document reading region SA and the reading window portion 21 in the sub scanning direction Y is the standby position P0 of the reading module 20. In the book scan mode, when the document cover 15 is switched from the closed state to the open state, the control unit 50 moves the reading module 20 from the standby position P0 indicated by the two-dot chain line in FIG. 13 to a document detection position P1 indicated by a solid line in FIG. 13. Then, the control unit 50 turns on the light emitting unit 18 in a state in which the reading module 20 is disposed at the document detection position P1. A turning-on start timing of the light emitting unit 18 may be in a state in which the reading module 20 is at the standby position P0 before the start of the movement, may be after the reading module 20 finishes moving to the document detection position P1 which is a target position, or may be during the movement of the reading module 20 from the standby position P0 to the document detection position P1. The light emitting unit 18 may start turning-on at least before the start of a predetermined period (for example, a predetermined value within a range of 1 to 10 seconds) in which the document detection process is performed after the reading module 20 finishes moving to the document detection position P1.

The user places the document M1 to cover the reading module 20 turned on at the document detection position P1 indicated by the solid line in FIG. 13 from above. That is, the user places the document M1 on the placement surface 12A in a state in which the reading module 20 (particularly, the reading unit 17) and the reading surface (for example, a reading target page) of the document M1 (book B1) face each other in the vertical direction Z.

### Display Control of Image Reading Apparatus 11

In each of the waiting states A, B, and D, the control unit 50 causes the display unit 41 to display guidance information for guiding a user operation that is an operation to be performed by the user according to each of the waiting states A, B, and D. For example, the control unit 50 causes the display unit 41 to display the guidance information as the user interface (GUI). The control unit 50 causes the display unit 41 to display the guidance screens D4, D5, D7, and D8 illustrated in FIGS. 11, 12, 17, and FIG. 18. The guidance screens D4, D5, D7, and D8 include the end button 81 in addition to the guidance information. The user can give an instruction to end the book scan mode to the image reading apparatus 11 by pressing the end button 81 not only in the document removal waiting state D but also in the cover open waiting state A and the document setting waiting state B. That is, the user can give the control unit 50 an instruction to end the mode, which is one of the predetermined conditions, in each of the waiting states A, B, and D. The control unit 50 displays the guidance screens D4, D5, D7, and D8 on the display unit 41 in each of the waiting states A, B, and D, and thus can receive a mode end instruction based on the user pressing the end button 81 by operating the input unit 42.

### Regarding Document Detection Process

Next, the document detection process will be described with reference to FIGS. 3, 13, and FIG. 14. When the document M1 is read in the open state in which the document cover 15 is opened with respect to the document table 12, the control unit 50 turns on the light emitting unit 18 at the document detection position P1 (see FIGS. 3 and 13) on the placement surface 12A of the document table 12 in the open state. That is, when receiving the job start instruction in the book scan mode, the control unit 50 turns on the light emitting unit 18 at the document detection position P1 on the placement surface 12A of the document table 12 when the document cover 15 is in the open state. Specifically, when receiving a job start instruction in the book scan mode, the control unit 50 first moves the reading module 20 to the document detection position P1. Next, the control unit 50 turns on the light emitting unit 18 in a state in which the reading module 20 is at the document detection position P1.

As illustrated in FIG. 13, the document detection position P1 may be a position within a range YA of a predetermined distance in the first direction +Y from a starting end Y0, which is an end of the placement surface 12A on the second direction -Y side (reading start position side). That is, the document detection position P1 may be a position closer to the standby position P0 in the sub scanning direction Y on the placement surface 12A.

The range YA to which the document detection position P1 belongs may be, for example, a range of 3 mm or more and 50 mm or less as a distance from the starting end Y0 in the first direction +Y. When the distance is less than 3 mm, a frequency of detection omission in which the book B1 cannot be detected tends to increase due to reading of a gap between the starting end Y0 and the book B1 even though the book B1 is placed. When the distance exceeds 50 mm, a movement time of the carriage 19 from the standby position P0 to the document detection position P1 is long, and thus a document detection delay is likely to occur. When the distance exceeds 50 mm, a time required for the reading unit 17 to move from the document detection position P1 to the reading start position Y0 after the detection of the document is long, and thus a delay of a reading start timing of the document M1 is likely to be induced.

Further, since the position exceeding 50 mm is likely to correspond to a position at which the book B1 is relatively likely to float in a central portion of the spread of the book B1, the book B1 is likely to be detected at a position of a portion where the book B1 is likely to float. In this case, the detection omission of the document M1 due to a detection target portion of the document M1 deviating from a depth of field of the reading unit 17 is likely to occur. In particular, when the reading module 20 is a CISM, since the depth of field is relatively shallow, document detection omission tends to occur easily. The range YA is not limited to the range of 3 mm or more and 50 mm or less in the first direction +Y from the starting end Y0, and a lower limit may be set to a value larger than 0 mm and less than 3 mm, or an upper limit may be set to a value larger than 50 mm. For example, the range YA may be a range of 1 mm or more and 10 mm or less in the first direction +Y from the starting end Y0. Alternatively, the range YA may be a range of 5 mm or more and 30 mm or less in the first direction +Y from the starting end Y0.

The turning-on of the light emitting unit 18 at the document detection position P1 under the open state of the document cover 15 may be continuous turning-on or blinking. In the present embodiment, the turning-on of the light emitting unit 18 is, for example, blinking. The control unit 50 causes the light emitting unit 18 to blink. The reading module 20 blinks at the document detection position P1 to guide the placement position of the book B1 on the placement surface 12A to the user. The blinking of the reading module 20 at the document detection position P1 also has a function of notifying the user that the image reading apparatus 11 is in the book scan mode.

The control unit 50 may cause the display unit 41 to display guidance information indicating that a turning-on position of the reading module 20 is the placement position where the document M1 is to be placed. The control unit 50 causes the display unit 41 to display guidance information indicating that the book B1 is placed at the document detection position P1, which is the position of the reading module 20 being turned on or blinking. The guidance information is, for example, a guide image including a GUI. The user who views the guidance information displayed on the display unit 41 places the book B1 on the document detection position P1 which is the turning-on position of the light emitting unit 18 on the placement surface 12A. The book B1 is placed on the placement surface 12A to cover the document detection position P1.

The control unit 50 detects the presence or absence of the book B1 on the placement surface 12A using the reading unit 17 at the document detection position P1. In the present embodiment in which the light emitting unit 18 blinks, the control unit 50 detects that the document M1 is placed on the placement surface 12A based on a reading result when the reading unit 17 is caused to perform reading when the light emitting unit 18 is turned on during blinking.

### Details of Document Detection Process

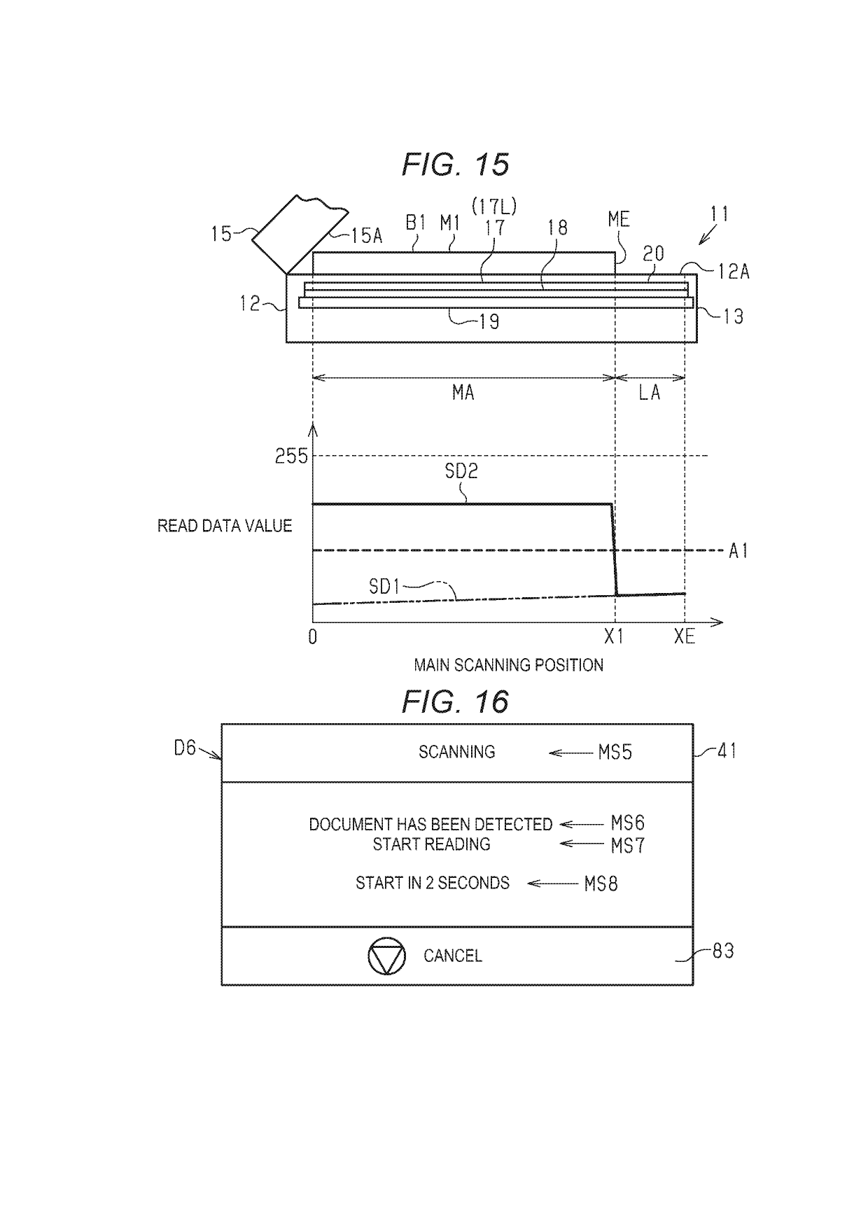

Next, the document detection process will be described in detail with reference to FIG. 15. FIG. 15 illustrates a schematic side cross-sectional view of the document table 12 on which the book B1 is placed and a graph illustrating a reading result of the reading unit 17. The control unit 50 executes the document detection process of causing the reading unit 17 to perform reading in a state in which the document cover 15 is in the open state and the light emitting unit 18 is turned on. The document detection process is a reading process for detecting that the document M1 is placed on the placement surface 12A. That is, in the present embodiment, the reading unit 17 is used to detect that the document M1 is placed on the placement surface 12A.

The control unit 50 causes the reading unit 17 to perform reading in a state in which the light emitting unit 18 is turned on from a time point when the document cover 15 is in the open state and before the document M1 is placed on the placement surface 12A. The control unit 50 starts the document detection process, which is a reading process for document detection, based on the result of the opening and closing sensor 23 detecting the open state of the document cover 15. The control unit 50 executes the document detection process in a state in which the reading unit 17 is disposed at the document detection position P1 in the document reading region SA of the placement surface 12A.

The graph illustrated in FIG. 15 illustrates the reading result of the reading unit 17 (line sensor 17L). A horizontal axis of the graph is the main scanning position indicating the position of each of the plurality of image sensors 28, and a vertical axis is a read data value. Here, the main scanning position corresponds to a pixel position indicating a position in the main scanning direction X of a plurality of (m) image sensors 28 constituting the reading unit 17. The read data value indicates a luminance value equivalent to a signal value at the time when luminance signals input from the plurality of image sensors 28 are converted into digital signals having predetermined tones (for example, 256 tones).

A reading result SD1 indicated by a two-dot chain line in the graph illustrated in FIG. 15 indicates a state before the document cover 15 is in the open state and the document M1 is placed on the placement surface 12A. A reading result SD2 indicated by a solid line in the graph illustrated in FIG. 15 indicates a reading result when the document M1 is placed on the placement surface 12A. The reading results SD1 and SD2 are indicated by read data in which the luminance value corresponding to a light receiving amount obtained by the image sensor 28 for each main scanning position is represented by, for example, 256 tones. Each of the reading results SD1 and SD2 indicates read data per reading of the line sensor 17L. The control unit 50 detects whether the document M1 is placed on the placement surface 12A based on the reading results SD1 and SD2 of the reading unit 17. That is, the control unit 50 determines that the document M1 is detected when there is a read data value (luminance value) exceeding a threshold A1 in the reading results SD1 and SD2.

As illustrated in FIG. 15, in a stage before the document M1 is placed on the placement surface 12A in which the document cover 15 is in the open state, the reading result SD1 indicated by the two-dot chain line in the graph is obtained. Since the reading unit 17 does not receive the reflected light from the document M1, there is no read data value exceeding the threshold A1. In this case, the control unit 50 does not detect that the document M1 is placed on the placement surface 12A.

On the other hand, when the document M1 is placed on the placement surface 12A, the reading unit 17 receives the reflected light from the document M1. Therefore, the reading result SD2 indicated by the solid line in FIG. 15 in which the read data exceeding the threshold A1 is present is obtained. A falling position X1 of the reading result SD2 corresponds to a position of a boundary between a bright region MA due to the reflected light of the book B1 and a dark region LA that does not receive the reflected light of the book B1. That is, the falling position X1 is a position corresponding to an end surface ME on the +X side of the book B1 placed on the placement surface 12A. Since there is read data exceeding the threshold A1 in the reading result SD2, the control unit 50 detects that the document M1 is placed. As described above, the control unit 50 performs the document detection process of detecting whether the document M1 is placed on the placement surface 12A based on the reading results SD1 and SD2.

In the document detection process, the above-described reading process in which reading is performed in a state in which the document cover 15 is in the open state and the light emitting unit 18 is turned on is referred to as a reading process As. The document detection process may include, in addition to the reading process As, a reading process Bs of reading in a state in which the document cover 15 is in the open state and the light emitting unit 18 is turned off. In this case, based on a difference between a reading result of the reading process As and a reading result of the reading process Bs, since there is data in which differential data exceeds a threshold, the control unit 50 may detect that the document M1 is placed on the placement surface 12A.

In a mode other than the book scan mode, the document detection process may include a reading process Cs for reading in the closed state of the document cover 15. For example, the document detection process may include the reading process As, the reading process Bs, and the reading process Cs that is reading in a state in which the document cover 15 is closed and the light emitting unit 18 is turned on. When a black document M1 is placed on the placement surface 12A, since the differential data between the reading result of the reading process As and the reading result of the reading process Bs does not exceed the threshold, the presence or absence of the black document M1 cannot be detected. However, the control unit 50 may detect the presence or absence of the black document M1 based on the differential data and a reading result of the reading process Cs. That is, when the differential data is smaller than the threshold and the reading result of the reading process Cs is smaller than the threshold, the control unit 50 determines that the document M1 is placed on the placement surface 12A. On the other hand, when the differential data is smaller than the threshold and the reading result of the reading process Cs is equal to or larger than the threshold, the control unit 50 determines that the document M1 is not placed on the placement surface 12A. According to the determination, it is also possible to detect that the black document M1 is placed on the placement surface 12A.

### Regarding FB Type Document Reading Process

Next, the document reading process in which the reading module 20 reads the document M1 using the FB type will be described. Contents of the document reading process are the same in the normal mode and the automatic mode or the manual mode of the book scan mode. The control unit 50 starts the document reading process based on establishment of a reading start trigger. The control unit 50 controls the carriage motor 43 to move the carriage 19 in the document reading region SA along the placement surface 12A in the sub scanning direction Y. The control unit 50 (for example, the light emission control unit 63) turns on the light emitting unit 18 during document reading. The control unit 50 (for example, the reading control unit 62) causes the reading unit 17 to read the document M1 through the transparent plate 14 in a state in which the light emitting unit 18 is turned on during the movement of the carriage 19. The reading unit 17 reads the document M1 by receiving the reflected light of light emitted by the light emitting unit 18 and reflected on the document M1. The control unit 50 acquires, from the reading control unit 62, read data read by the reading unit 17 in the document reading process. The control unit 50 generates image data by performing a necessary image process on the read data for each page. The control unit 50 executes a filing process of filing the image data into a file in a predetermined file format. The control unit 50 generates scan data in a predetermined file format by converting the image data into a file.

### Operation of First Embodiment

Next, an operation of the image reading apparatus 11 is described with reference to FIG. 10 and the like. Hereinafter, the book scan processing routine illustrated in FIG. 10 executed by the control unit 50 will be described. In the flowcharts illustrated in FIGS. 10, 19, and 20, alphabets "(A)", "(B)", and "(D)" indicating the corresponding waiting states are illustrated in the steps corresponding to the waiting states A, B, and D. That is, in the waiting states A, B, and D, guidance information for prompting the user to perform an operation (user operation) corresponding to the waiting states A, B, and D is displayed. In the steps of displaying the guidance information, alphabets indicating the waiting states A, B, and D corresponding to the respective guidance information are illustrated in parentheses ().

By operating the input unit 42, the user selects a reading condition, selects a mode, and issues a document reading start instruction (job start instruction). The control unit 50 executes a book scan processing routine illustrated in FIG. 10. In the book scan processing routine, when the control unit 50 receives a job start instruction in the book scan mode, the control unit 50 automatically starts reading (scanning) the document M1 every time it detects that the document M1 is placed on the placement surface 12A of the document table 12. The image reading apparatus 11 is in a normal mode at startup. When executing the book scan mode, the user selects the book scan mode with the mode selection button 70 on the selection screen D1 illustrated in FIG. 7, and instructs the start of the job with the job start button 71.

First, in step S11, the control unit 50 determines whether the book scan mode is selected and the job start button 71 is pressed. When the control unit 50 receives the selection of the book scan mode based on the pressing of the mode selection button 70 on the selection screen D1 and the job start instruction in the automatic mode based on the pressing of the job start button 71, the process proceeds to step S12. Otherwise, the control unit 50 waits until the book scan mode is selected and the job start button 71 is pressed.

In step S12, the control unit 50 transitions to the book scan mode. Specifically, the control unit 50 transitions to the automatic mode of the book scan mode. At this time, the control unit 50 shifts from the standby state to the document placement waiting state (document setting waiting state) in which the user waits for a user operation of placing the document M1 (book B1) on the placement surface 12A.

In step S13, the control unit 50 displays the guidance information prompting an opening operation of the document cover 15. At this time, the control unit 50 is in the cover open waiting state A. In the cover open waiting state A, the control unit 50 causes the display unit 41 to display, for example, the guidance screen D4 illustrated in FIG. 11. The guidance screen D4 includes, as the guidance information, the message MS1 indicating that the book scan mode is selected and the message MS2 prompting the user to open the document cover. As described above, the control unit 50 causes the display unit 41 to display the guidance screen D4 including the message MS2 prompting the user to open the document cover in the document placement waiting state. The user changes the document cover 15 from the closed state illustrated in FIG. 1 to the open state illustrated in FIG. 2 according to the guidance of the message MS2.

In step S14, the control unit 50 determines whether the document cover 15 is in the open state. The control unit 50 determines whether the document cover 15 is in the open state based on a determination result of the opening and closing determination unit 66 based on the detection signal of the opening and closing sensor 23. The control unit 50 proceeds the process to step S15 when the document cover 15 is in the open state, and returns the process to step S13 when the document cover 15 is not in the open state. In this case, the control unit 50 displays the guidance information for prompting an opening operation of the document cover 15 in step S13 until it is determined in step S14 that the document cover 15 is in the open state.

In step S15, the control unit 50 moves the carriage 19 to the document detection position P1. The control unit 50 drives the carriage motor 43 in a forward direction to move the carriage 19 from the standby position P0 to the document detection position P1, which is an example of a predetermined position. The document detection position P1 is a position at which the reading unit 17 detects whether the document M1 is placed on the placement surface 12A. The document detection position P1 according to the present embodiment is a position where the document M1 is placed so that the corner of the document M1 is aligned with the left back corner of the placement surface 12A (see FIG. 13). Therefore, the document detection position P1 is set at a position close to a left end (end portion on the -Y direction side) in the placement surface 12A (document reading region SA). Here, the document detection position P1 (predetermined position) is a position within the range YA of a predetermined distance from the starting end Y0 of the placement surface 12A in the +Y direction side.

In step S16, the control unit 50 starts detection of a document. The control unit 50 turns on the light emitting unit 18 and causes the reading unit 17 to start reading. The control unit 50 starts the document detection process of detecting whether the document M1 is placed on the placement surface 12A based on the reading result of the reading unit 17. The turning-on of the light emitting unit 18 at this time may be, for example, blinking. In this case, the control unit 50 causes the light emission control unit 63 to blink the light emitting unit 18 at a predetermined cycle. As illustrated in FIG. 13, the light emitting unit 18 of the reading module 20 blinks at the document detection position P1. The position where the light emitting unit 18 of the reading module 20 blinks guides the user to a document placement position where the document M1 is to be placed. The blinking of the reading module 20 has a guide function of guiding the user where the document detection position P1 is. The blinking of the reading module 20 also has a function of notifying the user that the image reading apparatus 11 is in the book scan mode or is in the document placement waiting state.

In the next step S17, the control unit 50 displays the guidance information prompting the placement of the document on the placement surface. At this time, the control unit 50 is in the document setting waiting state B. In the document setting waiting state B, the control unit 50 causes the display unit 41 to display, for example, the guidance screen D5 illustrated in FIG. 12. The guidance screen D5 includes notification information indicating the document placement position and the message MS4 prompting the user to place the document M1 at the document placement position. According to the guidance of the message MS4, as illustrated in FIGS. 13 and 14, the user places the document M1 (book B1) at the document detection position P1 to cover a blinking position on the placement surface 12A from above. That is, the user places the book B1 at the document placement position close to the left back side on the placement surface 12A. In this way, the book B1 is placed on the placement surface 12A at a position where the reading unit 17 at the document detection position P1 can read the book B1. The guidance screen D5 includes the end button 81 and a setting button 82. The guidance screen D5 includes the message MS3 indicating that the book scan mode is ended when the end button is pressed. The user presses the end button 81 to end the book scan mode. When the setting button 82 is selected, the control unit 50 causes the display unit 41 to display the first setting screen D2 illustrated in FIG. 8 or the second setting screen D3 illustrated in FIG. 9. For example, the user changes the standby time T1, which is an elapsed time from a time point when the book B1 is placed to the start of reading, as necessary on either of the setting screens D2 and D3.

In the next step S18, the control unit 50 determines whether the end button 81 is pressed. The control unit 50 proceeds the process to step S19 when the end button 81 is not pressed, and proceeds the process to step S24 when the end button 81 is pressed. Since not even a single page of the book B1 has been read yet, it is unlikely that the user will press the end button 81. Therefore, the process normally proceeds to step S19.

In the next step S19, the control unit 50 determines whether a document is detected. The control unit 50 determines whether the document is detected by the document detection process. The control unit 50 causes the light emitting unit 18 to blink in the document detection process. The control unit 50 executes the document detection process when the light emitting unit 18 is turned on among turning on and off. Here, the document detection process will be described with reference to FIG. 15. In a stage before the book B1 is placed on the placement surface 12A, the reading unit 17 does not receive the reflected light from the book B1 even when the light emitting unit 18 of the reading module 20 is turned on. Therefore, the reading result SD1 indicated by the two-dot chain line in FIG. 15 does not contain any read data that exceeds the threshold A1 at any main scanning position. Thereafter, when the book B1 is placed on the placement surface 12A, the light that is turned on by the light emitting unit 18 of the reading module 20 is reflected by the reading surface of the reading target page of the book B1, and the reading unit 17 receives the reflected light from the book B1. As a result, the read data value at the main scanning position in the region where the book B1 is placed in the reading result SD2 indicated by the solid line in FIG. 15 exceeds the threshold A1. The control unit 50 detects that the document M1 (book B1) is placed on the placement surface 12A when there is read data exceeding the threshold A1. When the document is detected, the control unit 50 proceeds the process to step S20. On the other hand, when no document is detected, the control unit 50 returns the process to step S17, and repeats the process of steps S17 to S19 until a document is detected in step S19.

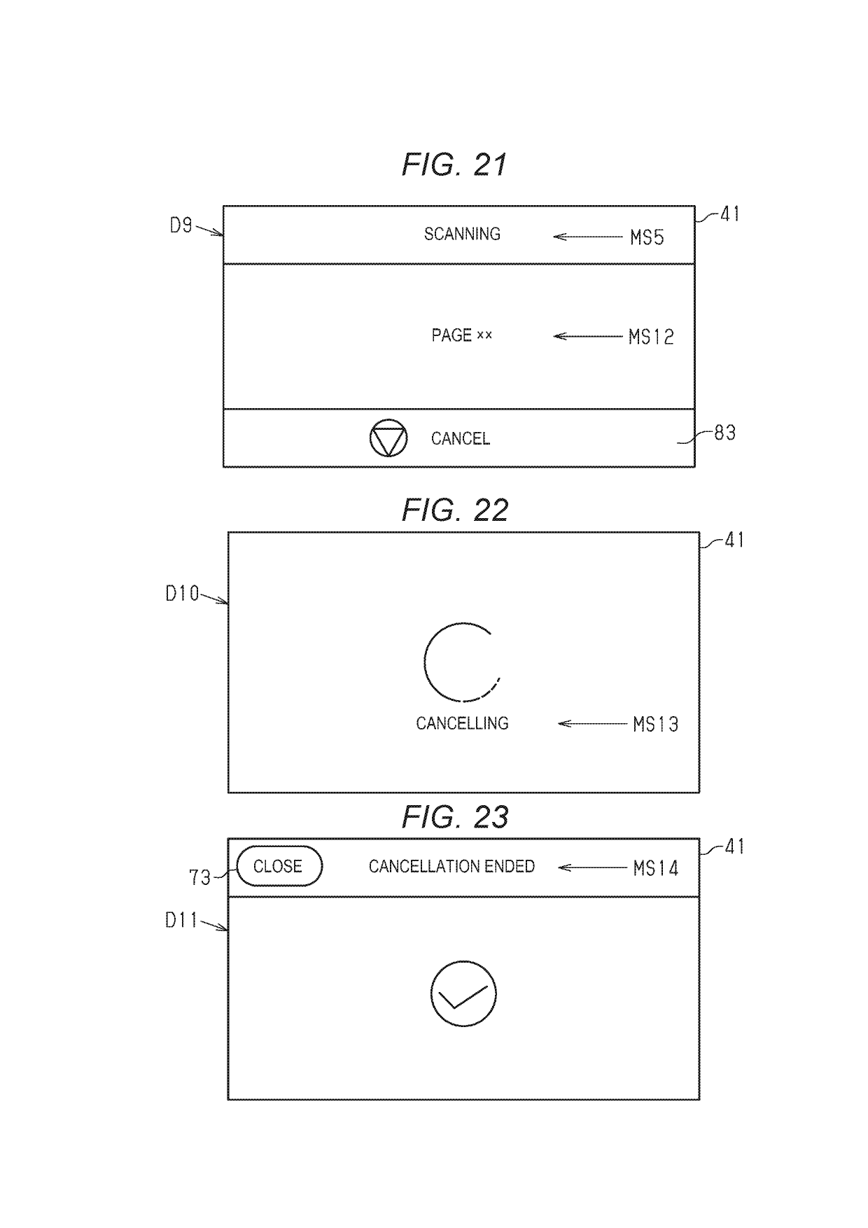

In step S20, the control unit 50 displays that scanning is in progress. For example, the control unit 50 causes the display unit 41 to display the notification screen D6 illustrated in FIG. 16. The notification screen D6 includes a message MS5 indicating that scanning is in progress as the notification information. However, the notification screen D6 illustrated in FIG. 16 is a screen in a state before the start of scanning. Therefore, the notification screen D6 includes a message MS6 indicating that the document is detected, a message MS7 indicating that the reading is started, and a message MS8 indicating a remaining time (seconds) until the reading is started in the standby time T1. The notification screen D6 includes the cancel button 83. When the reading (scanning) is started, the messages MS6 to MS8 may disappear and the notification screen D6 may be switched to the display content indicating the scanning state (see FIG. 21). When the cancel button 83 is pressed on the notification screen D6, the control unit 50 cancels the reading (scanning) of the book B1.

In step S21 illustrated in FIG. 10, the control unit 50 executes the document reading process (scanning). The control unit 50 moves the reading module 20 from the document detection position P1 (see FIG. 14) to the reading start position Y0 on a second direction -Y side. Next, the control unit 50 executes the document reading process of causing the reading module 20 to read the book B1 by moving the reading module 20 from the reading start position Y0 in the first direction +Y. For example, the reading module 20 moves in the first direction +Y from the reading start position Y0 to a reading end position PE, and moves in the second direction -Y from the reading end position PE to the document detection position P1. Here, the reading end position PE may be the terminal end YE of the document reading region SA, or may be an end portion position YM of the book B1 on the first direction +Y side or a position obtained by adding a predetermined margin distance to the end portion position YM. In this case, the control unit 50 detects the presence or absence of the book B1 based on the read signal from the reading module 20 during the reading process. The control unit 50 may acquire, as the end portion position YM of the book B1, a position where the book B1 is no longer detected from a state in which the book B1 is detected.

In step S22, the control unit 50 displays the guidance information prompting removal of the document. At this time, the control unit 50 is in the document removal waiting state D. In the document removal waiting state D, the control unit 50 causes the display unit 41 to display, for example, a guidance screen D7 illustrated in FIG. 17. The guidance screen D7 includes a message MS10 prompting the user to remove the document as the guidance information. The guidance screen D7 may include, as the notification information, a message MS9 for notifying that the scanning (reading of the document) is ended. The user who views the guidance screen D7 removes the book B1 from the placement surface 12A according to the guidance of the message MS10. Since the user knows that the scanning may be ended and the book B1 may be removed from the placement surface 12A from the guidance information by the messages MS9 and MS10, convenience is improved. For example, it is possible to reduce a useless waiting time for waiting for a while while holding the book B1 even though the scanning is ended. This leads to a reduction in the time required for reading a plurality of pages of the book B1.

In the next step S23 in FIG. 10, the control unit 50 determines whether the removal of the document is detected. The control unit 50 determines whether a document detection result is changed from a detection state in which the book B1 is detected to a non-detection state in which the book B1 is not detected by the document detection process similar to the document detection process in steps S16 and S19. The document detection position at this time may be a position different from the document detection position P1 in the sub scanning direction Y. The document detection position at which the removal of the document is detected may be a position in the middle of a path through which the reading module 20 that moves to the reading end position PE at which the reading of the document M1 is ended returns from the reading end position PE to the document detection position P1, or the document detection process may be started while the reading module 20 moves from the position in the middle of the path. In the document detection process, the control unit 50 turns on the light emitting unit 18 and causes the reading unit 17 to start reading for document detection. The control unit 50 determines whether the document M1 on the placement surface 12A has run out based on the reading result of the reading unit 17. The turning-on of the light emitting unit 18 at this time may be, for example, blinking. In this case, the control unit 50 may cause the light emission control unit 63 to blink the light emitting unit 18 at a predetermined cycle. Alternatively, the turning-on of the light emitting unit 18 may be continuous turning-on. In this case, the control unit 50 may detect the removal of the book B1 in a state in which the light emitting unit 18 is continuously turned on. The control unit 50 returns to step S22 while the removal of the document M1 (book B1) is not detected, and continues to display the guidance information prompting the removal of the document. On the other hand, when the removal of the document is detected, the control unit 50 returns to step S16. At this time, the control unit 50 shifts from the document removal waiting state D to the document setting waiting state B.

When the carriage 19 is in the middle of moving to the document detection position P1 when the removal of the document is detected, the control unit 50 may start the process of step S16 after waiting until the carriage 19 moves to the document detection position P1.

In step S16, the control unit 50 starts detection of a document. That is, the control unit 50 shifted to the document setting waiting state B starts the document detection process of detecting whether the document M1 whose reading surface is changed to the next page is placed on the placement surface 12A. Specifically, the control unit 50 turns on the light emitting unit 18 and causes the reading unit 17 to start reading. The control unit 50 determines whether the document M1 is placed on the placement surface 12A based on the reading results SD1 and SD2 of the reading unit 17 illustrated in FIG. 15. At this time, the light emitting unit 18 blinks at a predetermined cycle, for example. When the user places the book B1 changed to the next page on the placement surface 12A, as illustrated in FIG. 13, the image reading apparatus 11 guides the user to the document placement position by blinking the reading module 20 at the document detection position P1.

Then, in step S17, the control unit 50 causes the display unit 41 to display the guidance information prompting the placement of the document on the placement surface 12A. For example, the control unit 50 causes the display unit 41 to display a guidance screen D8 illustrated in FIG. 18. The control unit 50 counts the number of pages to be read of the document by a counter (not illustrated), and may display the guidance screen D8 on the display unit 41 when reading the second and subsequent pages. The guidance screen D8 includes a message MS11 prompting the user to place the next document on the placement surface 12A, and the end button 81. Further, the guidance screen D8 may include the message MS3 indicating that the end button 81 is pressed to end the book scan mode.

In this way, the user places the book B1 on the placement surface 12A while changing the page of the book B1 according to the guidance information and the notification information displayed on the display unit 41, thereby causing the image reading apparatus 11 to read a desired page of the book B1. The control unit 50 repeatedly executes the processes of steps S16 to 23 until the end button 81 is pressed in step S18. When the user finishes reading all the desired pages of the book B1, the user presses the end button 81 on the guidance screen D7 illustrated in FIG. 17 or the guidance screen D8 illustrated in FIG. 18. When the pressing of the end button is detected in step S18 (see also FIG. 19), the control unit 50 proceeds the process to step S24.

In step S24, the control unit 50 executes a filing process to generate a PDF file as an example of scan data. For example, the control unit 50 executes the filing process of combining the image data of a plurality of pages obtained by reading a plurality of pages of the book B1 into one file. For example, the control unit 50 generates the scan data by filing the image data of a plurality of pages of the book B1 into one file in a predetermined file format. The predetermined file format is, for example, a PDF format. The control unit 50 generates, as the scan data, a PDF file in which the image data for the plurality of pages is combined into one file.

### Mode Ending Process

Next, a mode ending process of ending the book scan mode when the predetermined condition is satisfied will be described with reference to FIG. 19. FIG. 19 illustrates a part of the book scan processing routine related to the mode ending process. Although FIG. 19 illustrates a process related to the mode ending process in the document setting waiting state B, the control unit 50 executes the same mode ending process also in the cover open waiting state A and the document removal waiting state D. The step numbers related to the mode ending process in the cover open waiting state A and the document removal waiting state D are illustrated in parentheses in FIG. 19.

Each process of steps S18, S31, and S32 in FIG. 19 corresponds to a process of determining whether the predetermined condition is satisfied. First, in step S17 (S13 and S22), the control unit 50 causes the display unit 41 to display the guidance information prompting a user operation according to the waiting state B (A, D) at that time. At this time, the guidance screen D5 (D4, D7) displayed on the display unit 41 has the end button 81 for instructing the end of the mode.

The user who finishes reading all the necessary pages of the book B1 presses the end button 81. When the control unit 50 receives the pressing of the end button 81 in step S18, the control unit 50 ends the book scan mode. The control unit 50 that ends the book scan mode proceeds the process to step S24, and performs the filing process of generating a file in a predetermined file format in which the read image data of a plurality of pages is combined into one. The control unit 50 generates, for example, a PDF file as a file in a predetermined file format by executing the PDF conversion process as the filing process.

After shifting to the waiting states A, B, and D, when the control unit 50 determines in step S31 that a timeout condition in which the predetermined time T2, which is one of the predetermined conditions, elapses is satisfied, the control unit 50 ends the book scan mode. The control unit 50 that ends the book scan mode proceeds the process to step S24 and generates a PDF file by performing the PDF conversion process as an example of the filing process.

In step S32, after shifting to the waiting states A, B, and D, the control unit 50 determines whether the document cover 15 is closed as one of predetermined conditions. When it is determined that the document cover 15 is closed, the control unit 50 ends the book scan mode. The control unit 50 that ends the book scan mode proceeds the process to step S24 and generates the PDF file by performing the PDF conversion process as an example of the filing process. The control unit 50 outputs the PDF file generated in step S24 from the image reading apparatus 11 to a designated storage destination (transmission destination). The PDF file is stored in, for example, a memory such as the host apparatus 200 that is the designated storage destination.

In addition, the control unit 50 performs an error detection process including a power supply system error while the image reading apparatus 11 is powered on. Also in the waiting states A, B, and D, the control unit 50 detects the presence or absence of the power supply system error in step S33. The power supply system error includes turning-off, unplugging, and the like. For example, when the user accidentally turns off or unplugs the power supply, the control unit 50 detects the power supply system error. When the power supply system error is detected, the control unit 50 ends the book scan mode. When the book scan mode is ended due to an error other than the predetermined condition, the control unit 50 does not perform the filing process. That is, the control unit 50 discards the read image data from the memory 52.

On the other hand, when the control unit 50 detects a user operation corresponding to the waiting states A, B, and D at that time in step S19 (S14 and S23) without satisfying any one of the predetermined conditions and without causing the power supply system error, the control unit 50 shifts from the waiting states A, B, and D to the next state. The control unit 50 that shifts to the next state executes processes to be performed in a shift destination state (step S20 (S15 and S16)).

In this way, in the waiting states A, B, and D, the control unit 50 executes the processes of determining whether the predetermined condition is satisfied (steps S18, S31, and S32), determining the power supply system error (step S33), and detecting the user operation (S19 (S14 and S23)). When the control unit 50 determines that the predetermined condition is satisfied, the control unit 50 ends the book scan mode and executes the filing process of generating a file in the predetermined file format in which the read image data is combined into one. As the filing process, the control unit 50 executes the PDF conversion process of generating a PDF file whose predetermined file format is the PDF format (step S24).

The control unit 50 outputs, from the image reading apparatus 11, the PDF file generated by the filing process to the outside designated as the storage destination. For example, the control unit 50 transmits the PDF file to the host apparatus 200 designated as the storage destination. Upon receiving the PDF file, the image reading control apparatus 300 stores the PDF file in a designated folder in the memory of the host apparatus 200.

### Process Related to Cancellation Process

Next, a process related to the cancellation process will be described with reference to FIG. 20. FIG. 20 illustrates a part of the book scan processing routine related to the cancellation process. In FIG. 20, the document reading process (step S21 in FIG. 10) is illustrated as a process from the start of the document reading process (step S211) to the end of the document reading process (step S213). During scanning from the start to the end of the document reading process, the user can instruct cancellation based on pressing of the cancel button 83. The notification screen D6 illustrated in FIG. 16 and a notification screen D9 illustrated in FIG. 21, which is switched when the document reading process is started after the standby time T1 elapses, include a message MS12 for notifying a page number of the page being read (being scanned) and the cancel button 83. Since the notification screens D6 and D9 are displayed on the display unit 41 during scanning after detecting that the document M1 is placed on the placement surface 12A, the user can press the cancel button 83.

When the cancel button 83 is pressed by the user (positive determination in step S212), the process proceeds to step S41, and the control unit 50 executes a cancellation process of canceling the reading (scanning) of the document M1. The control unit 50 displays a notification screen D10 illustrated in FIG. 22 during the cancellation process. The notification screen D10 includes a message MS13 indicating that the cancellation is in progress. When the cancellation process is ended, the control unit 50 switches the display content of the display unit 41 to a notification screen D11. The notification screen D11 includes a message MS14 indicating the end of cancellation.

When the cancellation process is ended, the control unit 50 shifts from the scanning state C to the document removal waiting state D. Further, when the state shifts to the document removal waiting state D, in step S22, the control unit 50 causes the display unit 41 to display the guidance information prompting the removal of the document M1. That is, the control unit 50 prompts the user to perform the document removing operation by displaying the guidance information on the display unit 41. The control unit 50 displays the guidance screen D7 substantially similar to that illustrated in FIG. 17 including the message MS10 as the guidance information prompting the removal of the document M1. However, at the end of the cancellation process, the content of the message MS9 in the guidance screen D7 is replaced with the notification information notifying the end of the scanning, and is set as the notification information notifying that the scanning is canceled.

In this way, even when the document reading process (scanning process) is canceled, the state shifts to the document removal waiting state D. Therefore, the user can re-read the page canceled due to a positional deviation or the like at an appropriate position. When the user cancels a page error, the user can skip a wrong page and read a correct page as a subsequent page.

### Effects of First Embodiment

According to the first embodiment, effects described below can be obtained.

(1-1) The image reading apparatus 11 includes the document table 12, the document cover 15, the reading unit 17, and the control unit 50. The document table 12 has the placement surface 12A on which the document M1 is to be placed. The document cover 15 opens and closes the placement surface 12A of the document table 12. The reading unit 17 reads the document M1 placed on the placement surface 12A of the document table 12 on an opposite side from the placement surface 12A. When a mode in which reading of a plurality of documents M1 is continuously performed for each of the documents M1 in an open state in which the document cover 15 is opened with respect to the document table 12 is selected, the control unit 50 ends the mode based on a predetermined condition being satisfied in a removal waiting state in which the document M1 for which reading is ended is to be removed from the document table 12. According to the configuration, since the plurality of documents M1 can be continuously read until the predetermined condition is satisfied, it is possible to improve convenience for a user.

(1-2) The predetermined condition is that the predetermined time T2 elapses in the removal waiting state. According to the configuration, the mode can be ended without the user performing a special operation.

(1-3) The control unit 50 continues the mode based on detecting that a document M1 is placed on the document table 12 after detecting that the document M1 is removed before the predetermined time T2 elapses in the removal waiting state. According to the configuration, the document M1 can be continuously read by removing the document M1 before the predetermined time T2 elapses in the removal waiting state and then placing the document M1 on the document table.

(1-4) The image reading apparatus 11 further includes the opening and closing sensor 23 that detects opening and closing of the document cover 15. The predetermined condition is that the opening and closing sensor 23 detects a closed state of the document cover 15 in the removal waiting state. According to the configuration, when the document cover 15 is closed after the reading of the plurality of documents M1 is ended, the mode can be ended.

(1-5) The predetermined condition is that an end of the mode is instructed by a user. According to the configuration, when the user instructs the end of the mode after the reading of the plurality of documents M1 is ended, the mode can be ended. The user can prevent the mode from being left running. For example, the mode can be ended before the predetermined time T2 elapses or before the document cover 15 is closed. By ending the mode early, it is possible to start a subsequent process such as the PDF conversion process early.

(1-6) The control unit 50 shifts to the removal waiting state when the reading of the document M1 is canceled by a user. According to the configuration, when the reading of the document M1 is canceled, the state shifts to the removal waiting state, and thus it is possible to continuously perform the reading of the canceled document M1 again. For example, when the cancellation is performed due to a positional deviation of the document M1, an error of a page to be read, or the like, it is possible to perform reading of the canceled document M1 again.

(1-7) When ending the mode based on the predetermined condition being satisfied, the control unit 50 converts the read image data into a PDF. According to the configuration, when the mode is ended based on satisfaction of the predetermined condition, the read image data is converted into a PDF, so that the read image data can be converted into a PDF without a special instruction other than the end of the mode. For example, when a plurality of pages of the document M1 are read, the pages can be combined and converted into a PDF.

(1-8) The image reading apparatus 11 includes the document table 12, the document cover 15, the light emitting unit 18, the document cover 15, and the control unit 50. The document table 12 has the placement surface 12A on which the document M1 is to be placed. The document cover 15 opens and closes the placement surface 12A of the document table 12. The reading unit 17 reads the document M1 placed on the placement surface 12A of the document table 12 on an opposite side from the placement surface 12A. When a mode in which reading of a plurality of documents M1 is continuously performed for each of the documents M1 in an open state in which the document cover 15 is opened with respect to the document table 12 is selected, the control unit 50 ends the mode based on an instruction issued by a user to end in any of the following three waiting states A, B, and D.

·The document cover open waiting state A for waiting for the open state of the document cover 15.

·The placement waiting state B in which the document M1 is placed on the document table 12.

·The removal waiting state D in which the document M1 for which reading is ended is to be removed from the document table 12.

According to the configuration, since the plurality of documents M1 can be continuously read until the predetermined condition is satisfied, it is possible to improve convenience for a user.

(1-9) The image reading apparatus 11 displays information and further includes the input unit 42 that can receive an input from a user. In the document cover open waiting state A, the document setting waiting state B (an example of the placement waiting state), the document removal waiting state D (an example of the removal waiting state), and a post-cancellation instruction waiting state E, the control unit 50 displays the end button 81 for receiving the end of the mode. When the end button 81 is pressed, the control unit 50 ends the mode and converts the read image data into a PDF. According to the configuration, unless a predetermined condition other than the condition for pressing the end button 81, which is one of the predetermined conditions, is satisfied in each of the waiting states A, B, and D, the plurality of documents M1 can be continuously read until the end button 81 is pressed. Therefore, the convenience for the user can be increased.

### Second embodiment

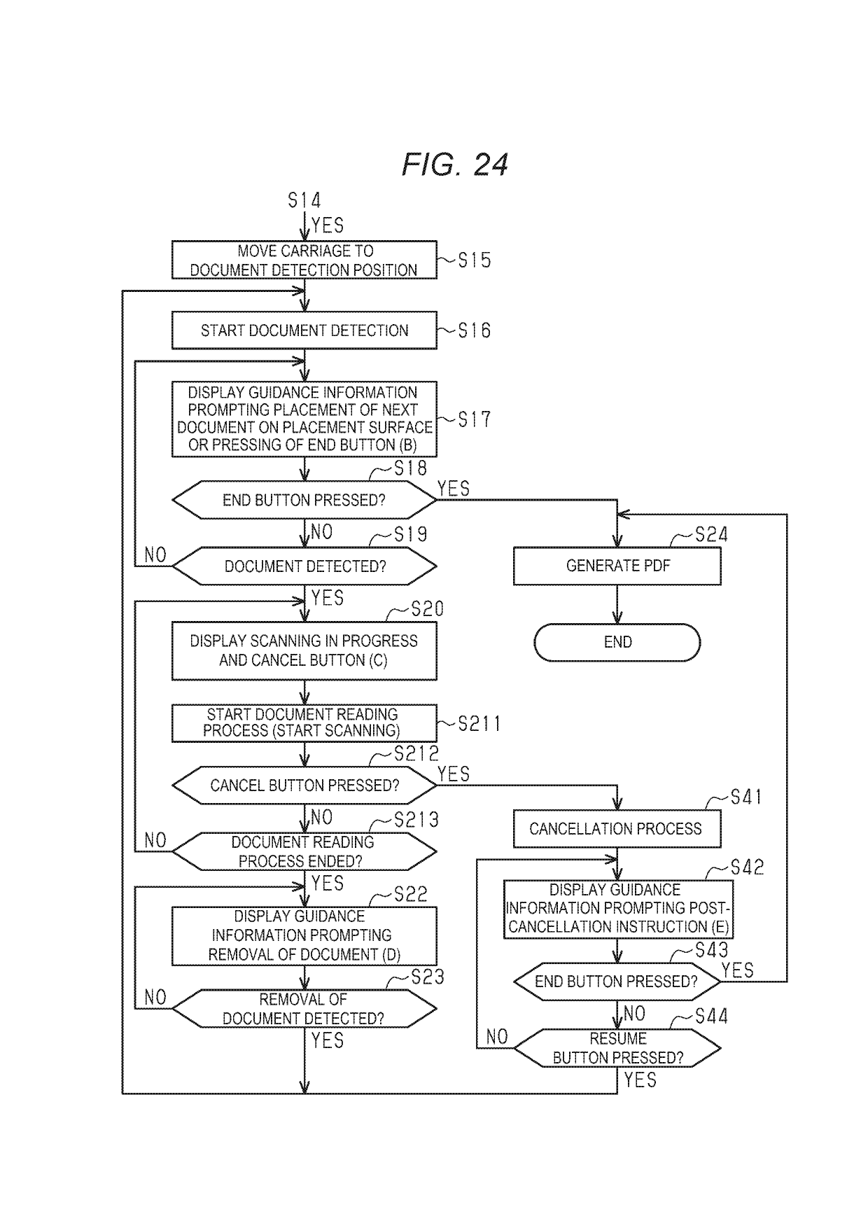

Next, a second embodiment will be described with reference to FIGS. 24 to 26. The second embodiment is different from the first embodiment in the process after the cancellation when the scanning is cancelled. The configuration of the image reading apparatus 11 and the processes other than the process after cancellation are basically the same as those of the first embodiment. Therefore, in the following, processes different from those of the first embodiment will be mainly described.

The image reading apparatus 11 stores the control program PR illustrated in a flowchart of FIG. 24 in which a part of the program for the book scan mode is changed in the memory 52. The control unit 50 executes the book scan processing routine in the second embodiment by executing the control program PR.

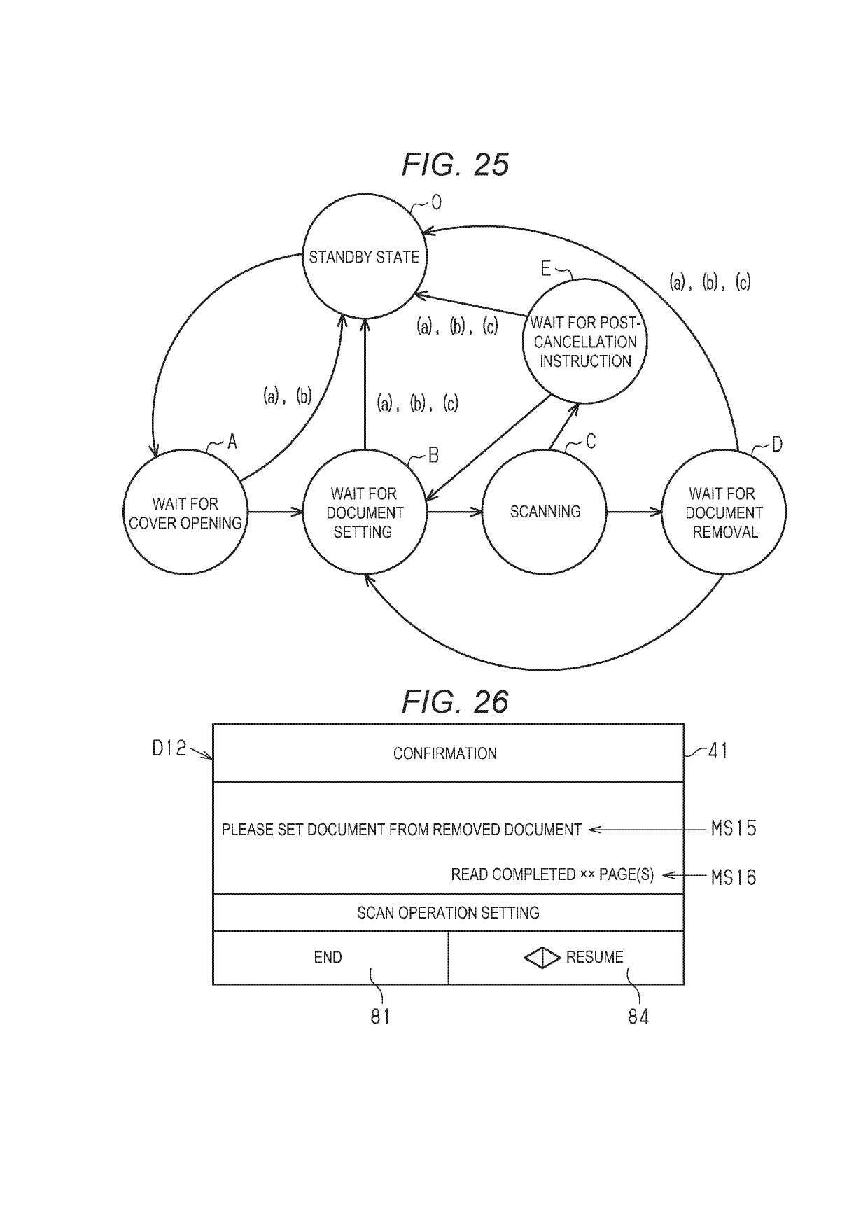

FIG. 25 illustrates a state transition of the book scan mode in the second embodiment. When the mode is canceled in the scanning state C, the state shifts to the "post-cancellation instruction waiting state E". In the "post-cancellation instruction waiting state E", when any one of the predetermined conditions (a) to (c) is satisfied, the book scan mode is ended and the state returns to the "standby state 0". In the first embodiment, when the cancellation is performed during scanning, the state shifts to the document removal waiting state D after the cancellation process. For example, when reading is started in a state in which a set position of the book B1 is deviated or the reading surface of the book B1 floats from the placement surface 12A, the user presses the cancel button 83. Upon receiving a cancel instruction based on pressing of the cancel button 83, the control unit 50 shifts to the document removal waiting state D. Therefore, even when it is desired to scan the same page of the currently set book B1 again, it is necessary to remove the book B1 from the placement surface 12A temporarily.

When the image reading apparatus 11 according to the second embodiment is cancelled in the scanning state C, the image reading apparatus 11 shifts to the "post-cancellation instruction waiting state E".

When the book scan mode is selected, the control unit 50 ends the book scan mode, which is an example of the mode, based on a predetermined condition being satisfied in any of the following four waiting states A, B, D, and E.

The document cover open waiting state A for waiting for the open state of the document cover 15.

The placement waiting state B in which the document M1 is placed on the document table 12.

The document removal waiting state D in which the document M1 for which reading is ended is to be removed from the document table 12.

The post-cancellation instruction waiting state E in which an instruction after the document reading process is cancelled by the user is waited.

In the three waiting states A, B, and D similar to the first embodiment, when any one of the predetermined conditions (a) to (c) described above is satisfied, the control unit 50 ends the book scan mode and returns to the "standby state 0". For example, in the three waiting states A, B, and D similar to the first embodiment, the control unit 50 ends the mode when any one of the predetermined conditions (a) to (c) is satisfied. In the second embodiment, even in the post-cancellation instruction waiting state E, the control unit 50 ends the mode when any one of the predetermined conditions (a) to (c) is satisfied.

One condition (a) of the predetermined condition is an end instruction for a mode. In any one of the four waiting states A, B, D, and E, the mode is ended based on an instruction to end which is issued by the user. In the three waiting states A, B, and D similar to the first embodiment, the control unit 50 ends the mode based on an instruction to end which is issued by the user. In the second embodiment, even in the post-cancellation instruction waiting state E, the control unit 50 ends the mode based on an instruction to end which is issued by the user.

In the first embodiment, the state shifts to the document removal waiting state D after the cancellation, whereas in the second embodiment, the state shifts to the post-cancellation instruction waiting state E after the cancellation. The control unit 50 displays the guidance screens D4, D5, D7, D8, and D12 having the end button 81 in the four waiting states A, B, D, and E. In the document cover open waiting state A, the placement waiting state B (document setting waiting state B), the document removal waiting state D, and the post-cancellation instruction waiting state E, the control unit 50 displays the end button 81 for receiving the end of the mode. The control unit 50 causes the display unit 41 to display the guidance screen D4 (FIG. 11), D5 (FIG. 12), D7 (FIG. 17), and D8 (FIG. 18) in the three waiting states A, B, and D in the first embodiment, and causes the display unit 41 to display the guidance screen D12 (see FIG. 26) in the post-cancellation instruction waiting state E.

FIG. 26 illustrates the guidance screen D12 displayed on the display unit 41 in the post-cancellation instruction waiting state E after the scanning process. The guidance screen D12 includes a message MS15 as an example of the guidance information for prompting the user to set a document and a message MS16 as an example of the notification information including information on the number of read pages. Further, the guidance screen D12 has the end button 81 similar to that of the first embodiment. The end button 81 is a button pressed by the user when an instruction to end the book scan mode is issued.

### Resume Process

When the book scan mode is canceled by the user, the control unit 50 causes the display unit 41 to display the guidance screen D12 (see FIG. 26) as an example of a resumption reception image indicating that resumption of the book scan mode is received. The control unit 50 resumes the book scan mode based on an instruction to resume the book scan mode which is issued by the user via the input unit 42.

The guidance screen D12, which is an example of the resumption reception image illustrated in FIG. 26, includes a resume button 84. The resume button 84 is a button including an image (GUI) indicating that the resumption of the book scan mode is received. The resume button 84 is a button to be pressed by the user when the reading of the page whose reading is canceled is resumed while the book B1 is placed on the placement surface 12A.

The guidance screen D12 includes the end button 81 and the resume button 84. In the guidance screen D12 displayed in the post-cancellation instruction waiting state E, the user can select one of an end instruction based on pressing of the end button 81 and a resume instruction based on pressing of the resume button 84.

In the first embodiment, when the book B1 canceled by the user remains placed on the placement surface 12A, the document removal waiting state D is set. When the canceled page of the book B1 is read again, it is necessary to shift from the document removal waiting state D to the document setting waiting state B by temporarily removing the book B1 from the placement surface 12A.

In contrast, in the second embodiment, when the resumption is received, the control unit 50 resumes the book scan mode and shifts from the post-cancellation instruction waiting state E to the document setting waiting state B. Therefore, by pressing the resume button 84 in the guidance screen D12, the user can resume the reading of the same page of the book B1 in the currently set state without removing the book B1 from the placement surface 12A. When the user temporarily removes the canceled book B1 from the placement surface 12A, the user may shift from the post-cancellation instruction waiting state E to the document setting waiting state B at that time. In this case, when the same page of the removed book B1 is placed on the placement surface 12A again, the reading of the canceled page can be resumed without a special operation.

### Operation of second embodiment

Next, an operation of the image reading apparatus 11 according to the second embodiment will be described with reference to FIG. 24 and the like. The control unit 50 receives a selection of the book scan mode as an example of a mode in which reading of a plurality of documents M1 is continuously performed for each document M1 in an open state in which the document cover 15 is opened with respect to the document table 12. Specifically, the user presses the mode selection button 70 and selects the job start button 71 on the selection screen D1 illustrated in FIG. 7. The control unit 50 transitions from the normal mode to the book scan mode.

As illustrated in FIG. 24, the process after the cancellation process (step S41) is different from that of the first embodiment. In the first embodiment, the state shifts to the "document removal waiting state D" after the cancellation process, whereas in the second embodiment, the state shifts to the "post-cancellation instruction waiting state E" for waiting for an instruction issued by the user after the cancellation process (step S41) (step S42). Here, the "post-cancellation instruction waiting state E" is a state of waiting for an instruction issued by the user after the cancellation process. In the post-cancellation instruction waiting state E, the control unit 50 displays the guidance information for prompting an instruction issued by the user as a user operation. The user can select one of the instructions from a plurality of options. After the cancellation process, the control unit 50 causes the display unit 41 to display the guidance information prompting the user to select one of the options and issue an instruction (step S42). The plurality of instruction options include two options of an end instruction to end the mode and a resume instruction to resume reading of the canceled document. The control unit 50 receives the instruction selected by the user after the cancellation.

Therefore, in step S43 illustrated in FIG. 24, when the control unit 50 receives an end instruction based on pressing of the end button 81, the control unit 50 ends the book scan mode and proceeds the process to step S24 to generate a PDF file. At this time, the control unit 50 shifts to the standby state 0 by the end of the mode (see FIG. 25).

On the other hand, when the control unit 50 receives the resume instruction based on the pressing of the resume button 84 in step S44, the process proceeds to step S16. At this time, the control unit 50 that receives the resume instruction shifts to the document setting waiting state B (see FIG. 25). In the document setting waiting state B, the user does not need to remove the book B1 from the placement surface 12A. When the control unit 50 starts the document detection process (step S16), the control unit 50 detects the document M1 on the placement surface 12A whose reading is canceled (step S19). Then, the control unit 50 resumes the reading of the canceled document M1 (S211 and S213).

### Process When Predetermined Condition Satisfied

Next, a process when a predetermined condition is satisfied will be described with reference to FIG. 19. In addition to the three waiting states A, B, and D in the first embodiment illustrated in FIG. 19, the post-cancellation instruction waiting state E is added in the second embodiment. When the control unit 50 is in the waiting states A, B, D, and E in the book scan mode, the control unit 50 determines whether any one of the predetermined conditions (a) to (c) is satisfied (steps S18, S31, and S32 in FIG. 19). When any one of the predetermined conditions (a) to (c) is satisfied, the control unit 50 generates a PDF file by executing a filing process of combining image data of one or more pages read from the memory 52 so far into one file (step S24). Specifically, the control unit 50 determines whether any one of the predetermined conditions (a) to (c) is satisfied when receiving a mode end instruction based on the user pressing the end button 81 (step S31), when a timeout is satisfied (step S31), or when closing of the document cover 15 is detected (step S32). When any one of the predetermined conditions (a) to (c) is satisfied, the control unit 50 ends the book scan mode and executes the PDF conversion process as the filing process. Accordingly, the control unit 50 generates, for example, a PDF file (step S24).

In the second embodiment, the post-cancellation instruction waiting state E is added to the three waiting states A, B, and D in the first embodiment. When any one of the predetermined conditions (a) to (c) is satisfied even in the post-cancellation instruction waiting state E, the control unit 50 ends the book scan mode and executes the filing process (for example, the PDF conversion process). The control unit 50 transmits the PDF file generated by the filing process to, for example, the host apparatus 200 designated as a storage destination from the image reading apparatus 11, thereby storing the PDF file in a designated folder in the memory of the host apparatus 200.

### Effects of Second Embodiment

According to the present embodiment, the effects same as the effects (1-1) to (1-9) of the first embodiment are obtained, and the following effects are further obtained.

(2-1) The image reading apparatus 11 includes the document table 12, the document cover 15, the reading unit 17, the light emitting unit 18, and the control unit 50. When a mode in which reading of a plurality of documents M1 is continuously performed for each of the documents M1 in an open state in which the document cover 15 is opened with respect to the document table 12 is selected, the control unit 50 ends the mode based on a predetermined condition being satisfied in any one of four states of the document cover open waiting state A, the placement waiting state B, the removal waiting state D, and the post-cancellation instruction waiting state E. According to the configuration, since the plurality of documents M1 can be continuously read until the predetermined condition is satisfied, it is possible to improve convenience for a user.

(2-2) The control unit 50 ends the mode based on an instruction to end which is issued by the user in any of the four states of the document cover open waiting state A, the placement waiting state B, the removal waiting state D, and the post-cancellation instruction waiting state E. In the second embodiment, the post-cancellation instruction waiting state E, which is a state of waiting for an instruction after the reading of the document M1 is cancelled by the user, is added. Also in the post-cancellation instruction waiting state, the mode is ended based on an instruction to end which is issued by the user. According to the configuration, it is possible to end the mode by the user instructing the end as one of the predetermined conditions. Therefore, the convenience for the user can be improved.

(2-3) Since the post-cancellation instruction waiting state E is added, the user can issue a desired instruction from among a plurality of instruction options to the image reading apparatus 11 after cancellation. That is, in the first embodiment, since the state shifts to the document removal waiting state D after the cancellation, the book scan mode is continued. In contrast, according to the second embodiment, in the post-cancellation instruction waiting state E to which the shift is made after the cancellation, the instruction options issued by the user are displayed on the display unit 41 after the cancellation. The instruction options include an instruction to end the book scan mode and an instruction to resume the book scan mode. After instructing the cancellation, the user can select whether to end the book scan mode or continue (resume) the book scan mode.

(2-4) When the mode is canceled by the user, the control unit 50 causes the display unit 41 to display the guidance screen D12 as an example of a resumption reception image indicating that resumption of the book scan mode is received. The control unit 50 resumes the book scan mode based on an instruction to resume the book scan mode which is issued by the user via the input unit 42. According to the configuration, when the user cancels the book scan mode, the user can resume the book scan mode by instructing the resumption of the mode via the input unit 42 on the guidance screen D12 which is an example of the resumption reception image displayed on the display unit 41.

(2-5) The guidance screen D12 includes the resume button 84 capable of instructing resumption of reading of a canceled page after the cancellation process. That is, the guidance screen D12, which is an example of the resumption reception image, includes the resume button 84 that can instruct the resumption. Therefore, the resume button 84 can be pressed according to the guidance information on the guidance screen D12 without providing a special mechanical switch or giving a special function to the mechanical switch.

(2-6) Upon receiving the instruction to resume in the post-cancellation instruction waiting state E, the control unit 50 shifts to the document setting waiting state B. For example, in the guidance screen D12, when the instruction to resume is issued via the resume button 84, the control unit 50 shifts to the document setting waiting state B (document placement waiting state) without shifting to the document removal waiting state D. Therefore, the user can resume reading the same page that is canceled while the book B1 is still set on the placement surface 12A. When the reading of the canceled page is resumed, it is not necessary to remove the book B1 temporarily and place it again. Therefore, compared to the first embodiment, convenience when the user reads a booklet such as the book B1 is improved.

(2-7) The image reading apparatus 11 displays information includes the input unit 42 that can receive an input from a user. In the document cover open waiting state A, the document setting waiting state B (an example of the placement waiting state), the document removal waiting state D (an example of the removal waiting state), and the post-cancellation instruction waiting state E, the control unit 50 displays the end button 81 for receiving the end of the mode. When the end button 81 is pressed, the control unit 50 ends the mode and converts the read image data into a PDF. According to the configuration, unless a predetermined condition other than the condition for pressing the end button 81, which is one of the predetermined conditions, is satisfied in each of the waiting states A, B, D, and E, the plurality of documents M1 can be continuously read until the end button 81 is pressed. Therefore, convenience for the user can be improved.

### Third Embodiment

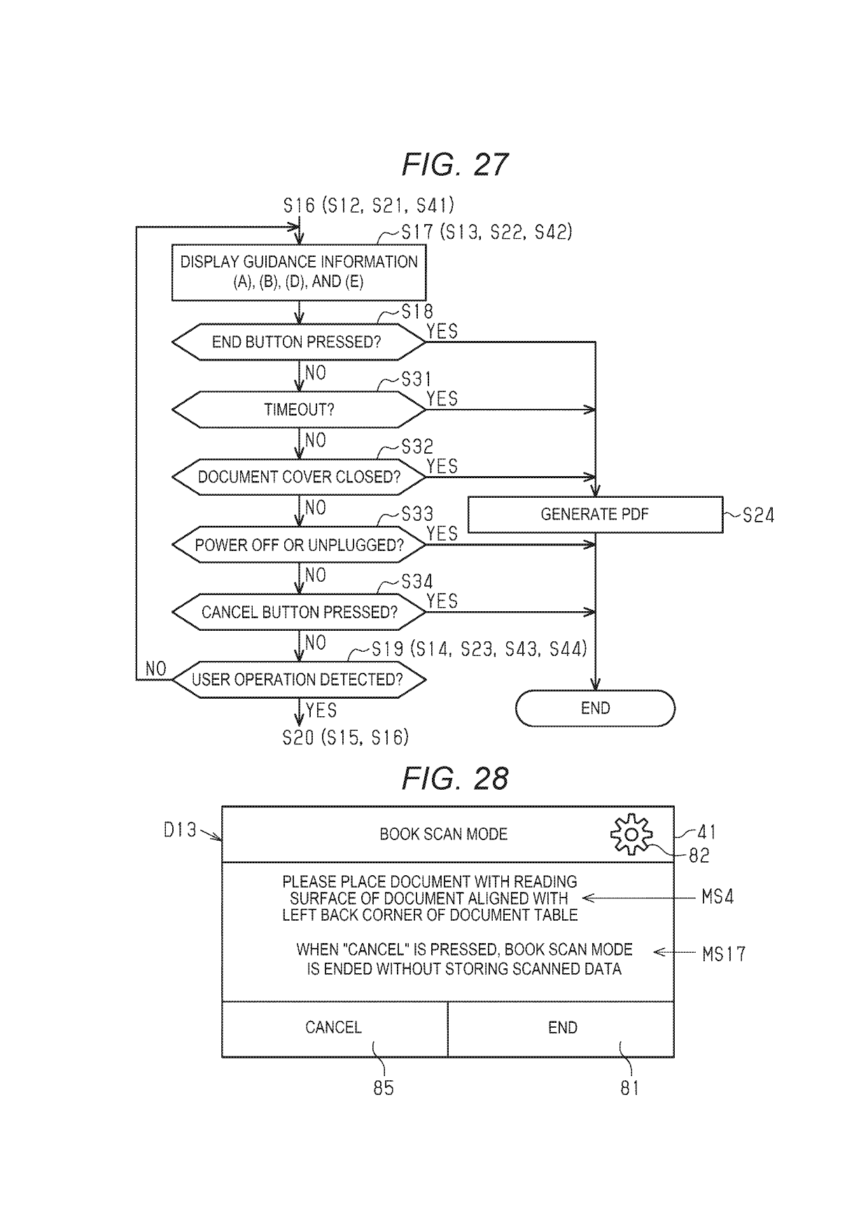

Next, a third embodiment will be described with reference to FIGS. 27 and 28. The third embodiment is a modification of the first and second embodiments. The image reading apparatus 11 stores the control program PR illustrated in a flowchart in FIG. 27 in the memory 52. The alphabets indicating the waiting states A, B, D, and E are illustrated in parentheses in step S17 in FIG. 27. However, in the case of the modification of the first embodiment, the states are the waiting states A, B, and D, and in the case of the modification of the second embodiment, the states are the waiting states A, B, D, and E. Hereinafter, for convenience of description, a modification of the second embodiment will be described as an example.

When any one of the predetermined conditions (a) to (c) is satisfied in the waiting states A, B, D, and E (positive determination in any one of steps S18, S31, and S32), the control unit 50 ends the book scan mode and executes the filing process (step S24). The control unit 50 generates scan data (for example, a PDF file) by executing the filing process, and transmits the generated scan data from the image reading apparatus 11 to a designated storage destination such as the host apparatus 200. However, even when the user does not desire the filing process, the scan data (for example, a PDF file) in a predetermined file format is stored in the host apparatus 200 such as a PC.

FIG. 28 is an example of a guidance screen D13 displayed in the waiting states A, B, D, and E in the third embodiment. In the guidance screen D13 illustrated in FIG. 28, the message MS4 indicates the guidance information when the document setting waiting state B is set. The guidance screen D13 in other waiting states A, D, and E also has basically the same screen content as that illustrated in FIG. 28, although the content of the message MS4 is the guidance information corresponding to each of the waiting states A, D, and E. The guidance screen D13 includes the end button 81 and a cancel button 85. The guidance screen D13 includes a message MS17 indicating that the book scan mode is ended without storing the scan data when the cancel button is pressed. The cancel button 85 is a button that can end the book scan mode without generating the scan data (for example, a PDF file) in a predetermined file format based on the filing process. When the user wants to end the book scan mode without storing the scan data in the waiting states A, B, D, and E, the user presses the cancel button 85 in the guidance screen D13 displayed on the display unit 41.

As illustrated in FIG. 27, in step S17 (S13, S22, and S42), the control unit 50 displays the guidance information in the waiting states A, B, D, and E. At this time, the control unit 50 causes the display unit 41 to display the guidance screen D13 as the guidance information. The control unit 50 determines whether the predetermined conditions (a) to (c) (steps S18, S31, and S32) are satisfied, and determines whether there is a power supply system error (step S33). Further, in step S34, the control unit 50 determines whether the cancel button 85 is pressed. When it is determined that the cancel button 85 is pressed, the book scan mode is ended without going through step S24 of generating the scan data (for example, a PDF file) by the filing process.

### Effects of Third Embodiment

According to the present embodiment, the effects same as the effects (1-1) to (1-9) of the first embodiment and the effects (2-1) to (2-7) of the second embodiment are obtained, and the following effects are further obtained.

(3-1) The image reading apparatus 11 causes the display unit 41 to display the guidance screen D13 having the cancel button 85 in the waiting states A, B, D, and E. By pressing the cancel button 85, the user can end the book scan mode without generating or transmitting the scan data to a designated storage destination.

### Fourth Embodiment

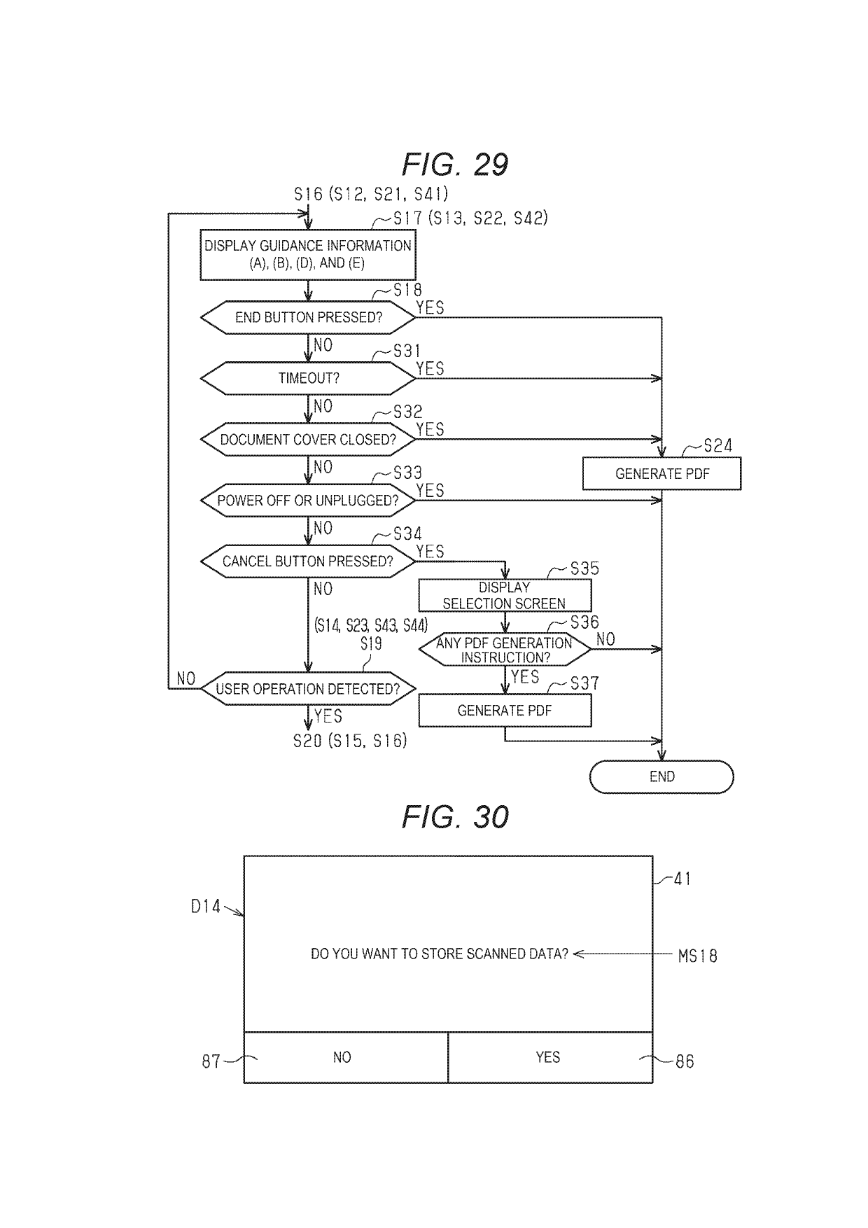

Next, a fourth embodiment will be described with reference to FIGS. 29 and 30. The fourth embodiment is a modification of the third embodiment. The image reading apparatus 11 stores the control program PR illustrated in a flowchart of FIG. 29 in the memory 52. In the third embodiment, when the cancel button 85 is pressed in the waiting states A, B, D, and E in the book scan mode, the scan data is not generated and is not stored in the designated storage destination. However, although the cancel button is pressed, there may be cases where the user intended to store the scan data. In the fourth embodiment, when the cancel button 85 is pressed, the control unit 50 causes the display unit 41 to display a selection screen D14 illustrated in FIG. 30 as the guidance information. The selection screen D14 includes a message MS18 for confirming whether to store the scan data. The selection screen D14 includes a YES button 86 to be selected when storing the scan data and a NO button 87 to be selected when not storing the scan data.

As illustrated in FIG. 29, in step S17 (S13, S22, and S42), the control unit 50 displays the guidance information in the waiting states A, B, D, and E. At this time, the control unit 50 causes the display unit 41 to display the guidance screen D13 (see FIG. 28) as the guidance information. In step S34, when the control unit 50 determines that the cancel button 85 is pressed under the waiting states A, B, D, and E, the control unit 50 proceeds the process to step S35 and causes the display unit 41 to display the selection screen D14 illustrated in FIG. 30. Therefore, the user can select whether to store the scan data. The user who wants to store the scan data presses the YES button 86. The user who does not want to store the scan data presses the NO button 87. The YES button 86 is an instruction (PDF generation instruction) to the image reading apparatus 11 to generate scan data (for example, a PDF file). In step S36, the control unit 50 determines whether there is a PDF generation instruction. When receiving a signal indicating that the YES button 86 is pressed, the control unit 50 receives the signal as the PDF generation instruction, and proceeds the process to step S37.

In step S37, the control unit 50 generates a PDF file as the scan data in which image data of one or more pages read so far is combined into one file. On the other hand, when receiving a signal indicating that the user presses the NO button 87, the control unit 50 determines that there is no PDF generation instruction. In this case, the control unit 50 ends the book scan mode without generating the scan data (for example, a PDF file).

### Effects of Fourth Embodiment

According to the present embodiment, the effects same as the effects (1-1) to (1-9) of the first embodiment and the effects (2-1) to (2-7) of the second embodiment are obtained, and the following effects are further obtained.

(4-1) When the cancel button 85 is pressed in the waiting state A, B, D, or E, the image reading apparatus 11 displays the selection screen D14. The selection screen D14 includes the buttons 86 and 87 with which the user can select whether to store the scan data. Therefore, the user can select whether to store the scan data after canceling the reading of the document M1 in the book scan mode. For example, it is possible to prevent the scan data from not being stored to a designated storage destination despite a user intention, even when the cancel button is pressed.

### Fifth Embodiment

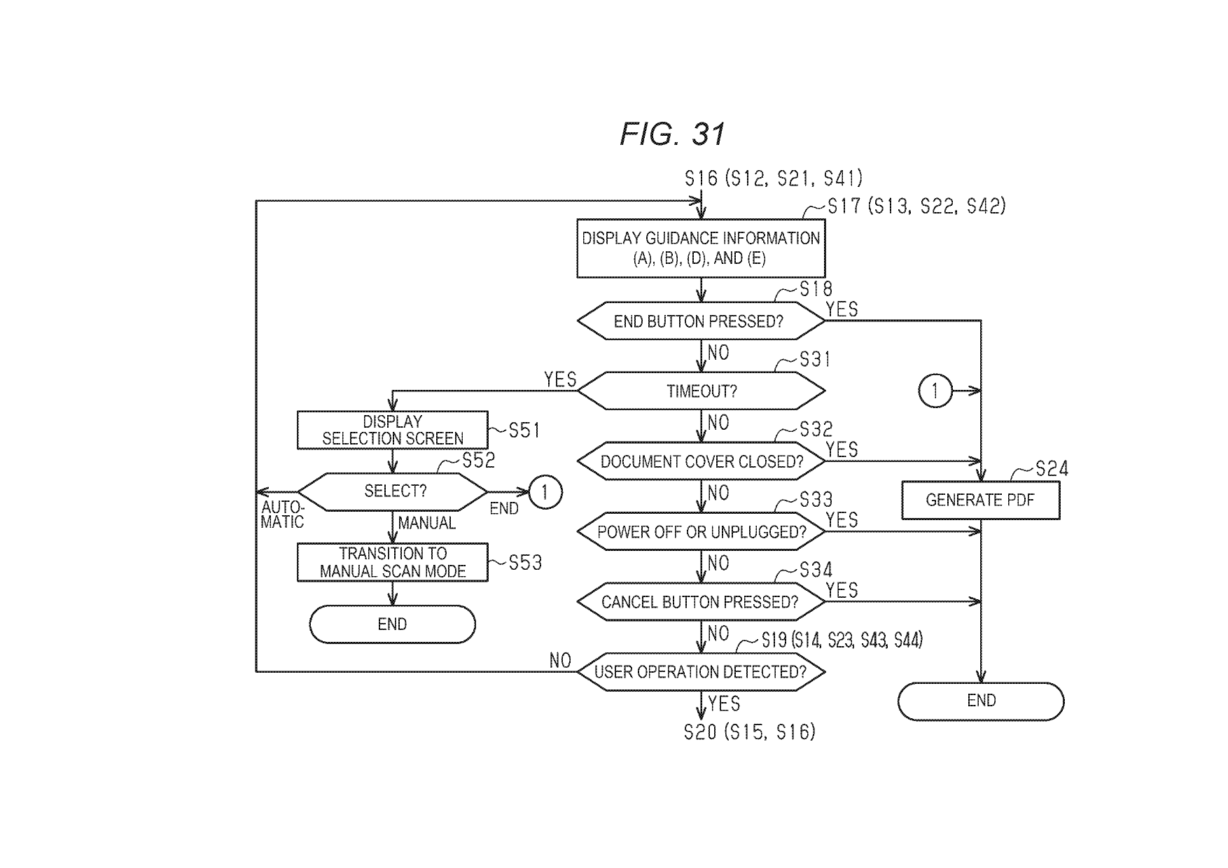

Next, a fifth embodiment will be described with reference to FIGS. 31 to 33 and the like. The fifth embodiment is a modification of the first to fourth embodiments. In the fifth embodiment, when a timeout is satisfied without detecting a user operation corresponding to the waiting states A, B, D, and E when the user is in the waiting states A, B, D, and E in the book scan mode, the automatic mode of the book scan mode is shifted to the manual mode.

The image reading apparatus 11 stores the control program PR illustrated in a flowchart of FIG. 31 in the memory 52. For example, in the document setting waiting state B, when a timeout is satisfied without detecting that a document is placed on the placement surface 12A, the mode is shifted from the book scan mode (automatic) to the manual mode. Specifically, when the control unit 50 detects that the document M1 is placed on the placement surface 12A based on a result of causing the reading unit 17 to perform reading in a state in which the document cover 15 is in the open state (positive determination in step S19 in FIG. 10, FIG. 24, or FIG. 31), the control unit 50 executes a document reading process of causing the reading unit 17 to read the document M1 (step S21 in FIG. 10 or steps S211 and S213 in FIG. 24). On the other hand, when it cannot be detected that a document is placed on the placement surface 12A, the control unit 50 shifts to a manual mode of performing reading manually by a user. Here, the undetectable state of the document corresponds to a state in which a timeout is satisfied without detecting that the document M1 is placed on the placement surface 12A.

Specifically, as illustrated in FIG. 31, in step S17, the control unit 50 displays the guidance information when in the document setting waiting state B. In the document setting waiting state B, when there is no mode end instruction (negative determination in step S18), the document cover 15 is not closed (negative determination in step S32), there is no power supply system error (negative determination in step S33), and there is no cancel instruction (negative determination in step S34), the process proceeds to step S19. Further, in step S19, when the user operation in the document setting waiting state B cannot be detected, that is, when the placement of the document M1 on the placement surface 12A cannot be detected, the control unit 50 returns to step S17. Thereafter, the control unit 50 repeats the processes of steps S17, S18, S31 to S34, and S19. When the timeout is satisfied in step S31, the process proceeds to step S51.

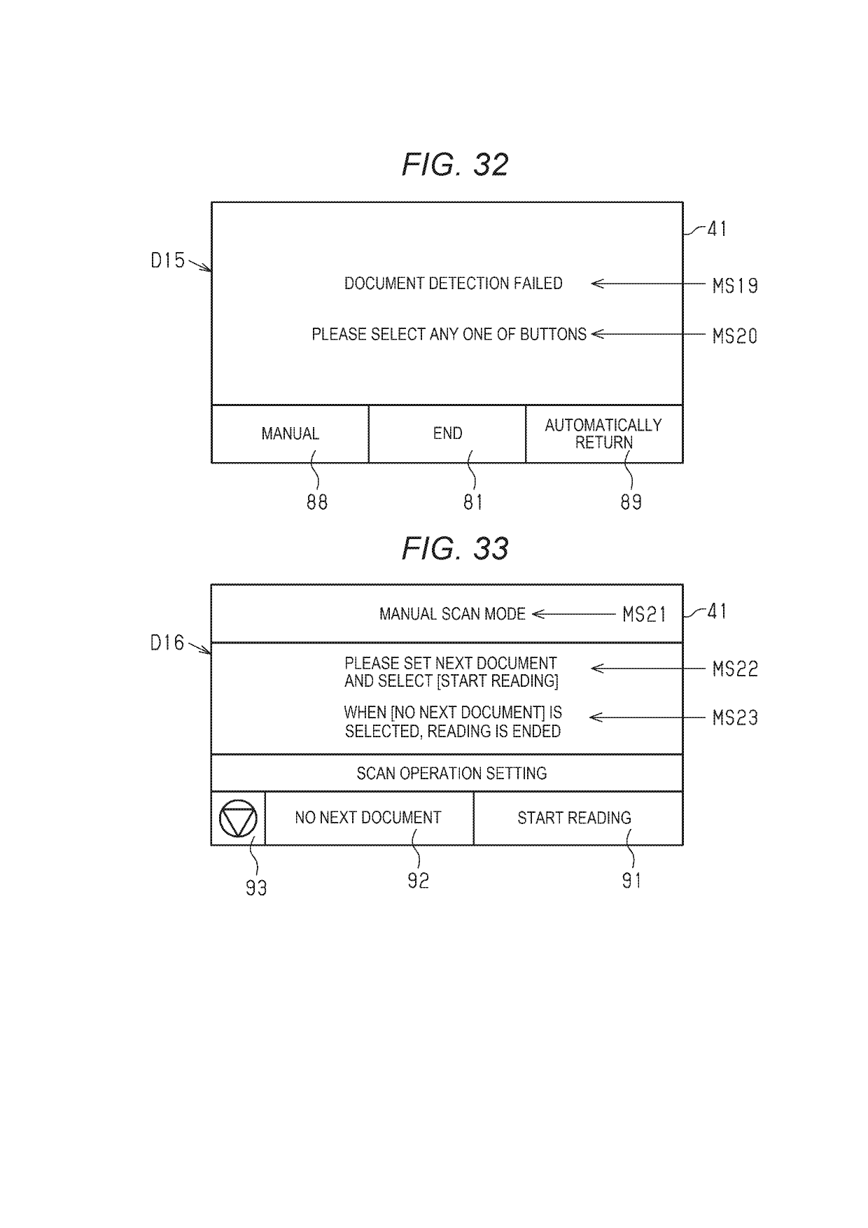

In step S51, the control unit 50 displays a selection screen. Specifically, the control unit 50 causes the display unit 41 to display a selection screen D15 illustrated in FIG. 32. The selection screen D15 includes a message MS19 indicating that the document cannot be detected. The selection screen D15 includes the end button 81, a manual button 88, and an automatic return button 89. The end button 81 is a button for selecting a mode end instruction to end the book scan mode. The manual button 88 is a button for selecting a manual mode. The automatic return button 89 is a button for selecting to return to the book scan mode (automatic). The selection screen D15 includes a message MS20 prompting a selection of any button.

When the control unit 50 receives a mode end instruction based on pressing of the end button 81, the control unit 50 ends the book scan mode and executes the filing process. When the control unit 50 receives a manual mode shift instruction based on pressing of the manual button 88, the control unit 50 shifts from the book scan mode (automatic) to the manual mode. Further, when receiving an automatic return instruction based on the pressing of the automatic return button 89, the control unit 50 returns to the book scan mode (automatic). That is, the book scan mode is continued by the selection of the user.

In step S52 illustrated in FIG. 31, the control unit 50 determines which button is selected. When the mode end instruction based on the pressing of the end button 81 is selected, the process proceeds to step S24, and the filing process is executed to generate a PDF file. In addition, when an automatic mode based on the pressing of the automatic return button 89 is selected, the process returns to step S17, and the process of the book scan mode is continued. Further, when a manual mode based on the pressing of the manual button 88 is selected, the process proceeds to step S53.

In step S53, the control unit 50 transitions to the manual scan mode. The manual scan mode is a manual book scan mode. The manual scan mode is a book scan mode in which a job start instruction is manually performed every time the document M1 is placed on the placement surface 12A.

After the transition to the manual scan mode, the control unit 50 executes a manual book scan process based on a program related to the manual scan mode. First, when transitioning to the manual scan mode, the control unit 50 displays a selection screen D16 illustrated in FIG. 33 on the display unit 41. The selection screen D16 includes a message MS21 indicating the manual scan mode. The selection screen D16 includes a reading start button 91, an end button 92, and a cancel button 93. Further, the selection screen D16 includes a message MS22 describing a selection of the reading start button 91 and a message MS23 describing a selection of the end button 92.

The reading start button 91 is a button that is pressed when an instruction to start a reading job is given after the next document M1 is set on the placement surface 12A. The end button 92 is a button that is pressed when there is no next document and an instruction to end the manual scan mode is given. The cancel button 93 is a button to be pressed to give an instruction to cancel reading (scanning).

Each time the user places the next document M1 on the placement surface 12A, the user presses the reading start button 91 to read the document M1. The control unit 50 executes one document reading process every time a job start instruction based on the pressing of the reading start button 91 is received. In the manual scan mode, the standby time T1 may or may not be set. When the standby time T1 is set, the control unit 50 starts the document reading process after the standby time T1 elapses from a time point at which the job start instruction based on the pressing of the reading start button 91 is received. The standby time T1 may be set to different values individually in the book scan mode and the manual scan mode. The standby time T1 in the manual scan mode may be a predetermined constant value.

As described above, in the fifth embodiment, the mode is shifted to the manual scan mode at the timeout in the document setting waiting state B (an example of the placement waiting state). The shift to the manual scan mode also shifts to the manual scan mode in timeout in the document cover open waiting state A, the document removal waiting state D (an example of the removal waiting state), and the post-cancellation instruction waiting state E. At this time, since the selection screen D15 is displayed after the timeout, the user can select whether to shift to the manual scan mode, end the book scan mode, or return to the book scan mode.

### Effects of Fifth Embodiment

According to the present embodiment, the effects same as the effects (1-1) to (1-9) of the first embodiment and the effects (2-1) to (2-7) of the second embodiment are obtained, and the following effects are further obtained.

(5-1) When it is detected that the document M1 is placed on the placement surface 12A based on a result of causing the reading unit 17 to perform reading in a state in which the document cover 15 is in the open state, the control unit 50 executes a document reading process of causing the reading unit 17 to read the document M1. When it cannot be detected that a document M1 is placed on the placement surface 12A, the mode shifts to the manual mode in which reading is manually performed by the user. According to the configuration, since the document reading process is executed when it is detected that the user places the document M1 on the placement surface 12A, the user does not need to instruct reading of the document M1 each time the document M1 is placed. For example, since the user can concentrate on positioning of the document M1 placed on the placement surface 12A, it is easy to prevent the positional deviation of the read image. When it cannot be detected that the user placed the document M1 on the placement surface 12A, the mode is shifted to the manual mode. Even when the book scan mode is ended, the user can perform reading of the document M1 in the manual mode.

### Modifications

The above embodiments may be modified as the following modifications. Further, an appropriate combination of the embodiments described above and the modifications described below can be obtained as another modification and an appropriate combination of the modifications described below can be obtained as another modification.

In each of the embodiments, the predetermined condition for ending the book scan mode, which is an example of the mode, may be only one or only two of the three conditions (a) to (c). For example, the predetermined condition may be only the condition (a), only the condition (b), or only the condition (c). The predetermined condition may be two conditions (a) and (b), two conditions (b) and (c), or two conditions (a) and (c).

The waiting state to which the predetermined condition is applied in the first to fifth embodiments and the modification may be any one of the waiting states A, B, D, and E. For example, at least one of the predetermined conditions (a) to (c) may be applied only to the document removal waiting state D. At least one of the predetermined conditions (a) to (c) may be applied only to the document setting waiting state B. At least one of the predetermined conditions (a) to (c) may be applied to the document setting waiting state B and the document removal waiting state D. For example, in at least one of the document setting waiting state B and the document removal waiting state D, the mode may be ended based on a predetermined condition being satisfied. For example, in the document removal waiting state D, the predetermined condition may be applied to the document setting waiting state B without applying the predetermined condition. In the document removal waiting state D in which the document M1 is placed on the placement surface 12A, since there is a relatively high possibility that the reading of the document M1 is continued, the predetermined condition which is the mode end condition may not be applied. Even with such a configuration, it is possible to end the book scan mode based on the predetermined condition being satisfied in the document setting waiting state B after the document M1 is removed from the placement surface 12A.

In the first to fifth embodiments and the modification, the predetermined condition applied to the waiting states A, B, D, and E may be the same, or the predetermined condition applied to the waiting states A, B, D, and E may be different.

A configuration in which the predetermined time T2 can be adjusted may be adopted. For example, a setting screen similar to the first setting screen D2 illustrated in FIG. 8 or the second setting screen D3 illustrated in FIG. 9 may be displayed on the display unit 41 so that the user can adjust the predetermined time T2 based on the operation of the input unit 42.

In the second to fifth embodiments, a guidance screen or a selection screen substantially similar to the guidance screen or the selection screen displayed on the display unit 41 may be displayed on the display unit 210 of the host apparatus 200. In this case, the image reading control apparatus 300 that receives an instruction based on a signal obtained by pressing a button on the guidance screen or the selection screen displayed on the display unit 210 transmits the received instruction to the control unit 50 of the image reading apparatus 11 via communication.

In the second embodiment, the guidance screen D12, which is an example of the resumption reception image, may not include the resume button 84. For example, the book scan mode may be resumed by operating an input unit including a mechanical switch according to the guidance information of the guidance screen D12. That is, upon receiving an instruction to resume from an input unit including a mechanical switch, the control unit 50 may resume the book scan mode.

A sensor that detects that the document M1 is placed on the placement surface 12A may be provided separately from the reading unit 17. For example, at least one document detection sensor may be provided at a position different from the document detection position P1 of the reading unit 17 in the document reading region SA of the placement surface 12A in a plan view of the document table 12 of the image reading apparatus 11. The sensor may be, for example, a reflective photosensor. Even when the document M1 is placed at a position different from the document detection position P1 at which the reading unit 17 performs the document detection process of detecting the document M1, the placement of the document M1 can be detected by the optical sensor. Therefore, the document detection omission can be prevented.

The document M1 (book B1) placed on the placement surface 12A may be detected by a sensor different from the reading unit 17. For example, the placement of the document may be detected by a photosensor (optical sensor).

The job start button 71 is not limited to the GUI displayed on the display units 41 and 210, and may be a mechanical switch. For example, the image reading apparatus 11 may include a job start button for starting a job as the mechanical switch. The mechanical switch is not limited to the dedicated job start button. For example, after the book scan mode is selected, a predetermined mechanical switch may function as the job start button. In this case, not only the image reading apparatus 11 but also a specific key switch constituting the input unit 220 of the host apparatus 200 after the book scan mode is selected may function as the job start button. In addition, at least one of various buttons such as an end button and a cancel button, which are buttons other than the job start button 71 in each embodiment, may be implemented by a mechanical switch.

In each of the embodiments, only one of the automatic mode and the manual mode (manual scan mode) constituting the book scan mode may be provided. For example, only the automatic mode may be provided, or only the manual mode may be provided. That is, a mode in which a plurality of documents are read for each of the documents under the open state of the document cover 15 may be an automatic mode (automatic book scan mode) or a manual mode (manual book scan mode). In these configurations, at least one of the predetermined conditions (a) to (c) may be applied as the mode end condition in the waiting state. The manual mode includes waiting states A and D in the first embodiment and the waiting states A, D, and E in the second embodiment. In the manual mode in which the predetermined time T2 of the timeout is measured based on the job start instruction and the document detection process is started from the job start instruction, there are the waiting states A, B, and D in the first embodiment and the waiting states A, B, D, and E in the second embodiment.

In the fifth embodiment, when the cancel button 85 (see ) is pressed (positive determination in step S34), the selection screen D15 having the manual button 88 with which the user can select the shift to the manual scan mode may be displayed on the display unit 41. In addition, in at least one of the waiting states A, B, D, and E, the control unit 50 may cause the display unit 41 to display the manual button 88 that is pressed when instructing the shift to the manual scan mode on the GUI. For example, at least one of the guidance screens D4, D5, D7, D8, D12, and D13 may include the manual button 88. According to the configuration, the user can select the shift from the book scan mode to the manual scan mode in any of the waiting states A, B, D, and E.

The job start button 71 may be omitted. For example, the book scan mode may be only the automatic mode, and the job start instruction in the automatic mode of the book scan mode may be performed based on the pressing of the mode selection button 70.

Before the document reading process (scanning), a preliminary reading process (pre-scanning) of the document M1 may be performed. In this case, when the control unit 50 detects that the document M1 is placed on the placement surface 12A by the document detection process, the control unit 50 may execute the preliminary reading process (pre-scanning). The purpose of the preliminary reading process may be detection of a document size or may be image confirmation (preview) in which the user confirms the document image in advance. The image of the document read in the preliminary reading process may be previewed on the display unit 210 of the host apparatus 200. In this case, only the first page in the book scan mode may be previewed, or all pages may be previewed. The control unit 50 may be implemented to execute the document reading process when the user who confirms a preview screen by the preliminary reading process presses the OK button. Setting changes such as an image density change and a resolution change may be performed on the preview screen displayed on the display unit 210 of the host apparatus 200.

The image reading apparatus 11 may not have a document detection function of detecting the document M1. The control unit 50 may be implemented to cause the reading unit 17 to execute a document reading process of causing the reading unit 17 to read a document based on the fact that the standby time T1 elapses from a time point when two conditions, that is, the fact that the document cover 15 is in the open state and the fact that a job start instruction is received from the user for each reading, are satisfied.

The reading unit 17 is not limited to the CIS type and may adopt a charge coupled device (CCD) type (a reduction optical type).

An opening and closing movement of the document cover 15 with respect to the document table 12 is not limited to the configuration of only a pivot movement. The opening and closing movement of the document cover 15 may include, for example, a pivot movement and a linear movement. For example, the opening and closing movement of the document cover 15 may include an upward movement in which the document cover 15 is moved upward while maintaining a predetermined posture, or a horizontal sliding movement in which the document cover 15 moves horizontally in the X direction.

The document M1 read in the open state of the document cover 15 is not limited to a booklet such as the book B1, and may be a document printed on a sheet such as a single sheet. In this case, the document M1 as a single sheet may have a size larger or smaller than the size of the placement surface 12A. The single sheet document M1 may be placed with a part thereof protruding from the placement surface 12A or may be placed without protruding. Further, the document M1 may be a three-dimensional object other than the book B1. In addition, various documents that are preferably read in the open state of the document cover 15 or a document that is desired to be read in the open state of the document cover 15 due to circumstances of a user may be used.

The image reading apparatus 11 may include a speaker that announces the guidance information and the notification information by voice in addition to the configuration of displaying the guidance information and the notification information on the display units 41 and 210.

A part or all of the control unit 50 may be implemented by hardware using an electronic circuit such as an application specific integrated circuit (ASIC) or a field-Programmable gate array (FPGA), or may be implemented by only software.

The image reading apparatus 11 may not include the automatic document feeder 24. That is, the image reading apparatus 11 may be a flatbed image reading apparatus not including an ADF type image reading function.

The image reading apparatus 11 may have a configuration in which the document table 12 having the placement surface 12A on which the document M1 can be placed, the reading unit 17, and the light emitting unit 18 are relatively movable in the sub scanning direction Y. For example, the image reading apparatus 11 may be implemented to read the document M1 placed on the placement surface 12A of the document table 12 by relatively moving the document table 12 in the sub scanning direction Y with respect to the upper surface opening of the housing 13 incorporating the reading unit 17 and the light emitting unit 18 in a state of being fixed at a predetermined position.

The image reading apparatus 11 may be a single scanner or a part of a multifunction peripheral. When the image reading apparatus 11 is a part of a multifunction peripheral, the image reading apparatus 11 may be mounted on an upper portion of a printing apparatus. This type of multifunction peripheral may be a small multifunction peripheral for personal or household consumers or a large multifunction peripheral for business or office use.

The expression "at least one" used in the present specification means "one or more" of desired choices. For example, the expression "at least one" used in the present specification means "only one choice" or "both of two choices" when the number of choices is two. As another example, the expression "at least one" used in the present specification means "just one choice" or "a combination of two or more any choices" when the number of the choices is three or more.

### Technical Ideas

As below, technical ideas grasped from the embodiment and the modifications explained above are described together with effects.

[1] An image reading apparatus includes: a document table having a placement surface on which a document is to be placed; a document cover configured to open and close the placement surface of the document table; a reading unit configured to read a document placed on the placement surface of the document table on an opposite side from the placement surface; and a control unit. When a mode in which reading of a plurality of documents is continuously performed for each of the documents in an open state in which the document cover is opened with respect to the document table is selected, the control unit ends the mode based on a predetermined condition being satisfied in a removal waiting state in which a document for which reading is ended is to be removed from the document table. According to the configuration, since it is possible to continuously read a plurality of documents until a predetermined condition is satisfied, it is possible to improve convenience for the user.

[2] In the image reading apparatus according to [1], the predetermined condition may be that a predetermined time elapses in the removal waiting state. According to the configuration, the mode can be ended without the user performing a special operation.

[3] In the image reading apparatus according to [1] or [2], the control unit may continue the mode based on detecting that a document is placed on the document table after detecting that the document is removed before the predetermined time elapses in the removal waiting state. According to the configuration, when the document is removed before the predetermined time elapses in the removal waiting state and then the document is placed on the document table, the document can be continuously read.

[4] The image reading apparatus according to any one of [1] to [3] may further include: an opening and closing sensor configured to detect opening and closing of the document cover. The predetermined condition is that the opening and closing sensor detects a closed state of the document cover in the removal waiting state. According to the configuration, when the document cover is closed after the reading of the plurality of documents is ended, the mode can be ended.

[5] In the image reading apparatus according to any one of [1] to [4], the predetermined condition is that an end of the mode is instructed by a user. According to the configuration, the user who finishes reading the plurality of documents can end the mode by instructing the end of the mode. It is possible to prevent the user from being left in the used mode.

[6] In the image reading apparatus according to any one of [1] to [5], when it is detected that a document is placed on the placement surface based on a result of causing the reading unit to read in a state in which the document cover is opened, the control unit executes a document reading process of causing the reading unit to read the document, and, when it cannot be detected that a document is placed on the placement surface, the control unit shifts to a manual mode of performing reading manually by a user. According to the configuration, since the document reading process is executed when it is detected that the user places the document on the placement surface, the user does not need to instruct reading of the document each time the document is placed. For example, since the user can concentrate on positioning of the document placed on the placement surface, it is easy to prevent the positional deviation of the read image. When it cannot be detected that the user placed the document on the placement surface, the mode is shifted to the manual mode. Even when the mode is ended, the user can cause the document to be read in the manual mode.

[7] In the image reading apparatus according to any one of [1] to [6], the control unit shifts to the removal waiting state when the reading of the document is canceled by a user. According to the configuration, when the user cancels the reading of the document, the state shifts to the removal waiting state, and thus it is possible to continuously perform the reading of the canceled document again.

[8] The image reading apparatus according to any one of [1] to [7] may further include: a display unit configured to display information; and an input unit configured to receive an input from a user. The control unit causes the display unit to display a resumption reception image indicating that resumption of the mode is received when the mode is canceled by the user, and resumes the mode based on an instruction to resume the mode by the user via the input unit. According to the configuration, when the user cancels the mode, the user can resume the mode by viewing the resumption reception image displayed on the display unit and issuing an instruction to resume the mode via the input unit.

[9] In the image reading apparatus according to any one of [1] to [8], when ending the mode based on the predetermined condition being satisfied, the control unit converts read image data into a PDF. According to the configuration, when the mode is ended based on the predetermined condition being satisfied, the read image data is converted into a PDF, so that the read image data can be converted into a PDF without a special instruction other than the end of the mode. For example, when a plurality of pages of a document are read, they can be combined into one PDF.

An image reading apparatus includes: a document table having a placement surface on which a document is to be placed; a document cover configured to open and close the placement surface of the document table; a reading unit configured to read a document placed on the placement surface of the document table on an opposite side from the placement surface; and a control unit. When a mode in which reading of a plurality of documents is continuously performed for each of the documents in an open state in which the document cover is opened with respect to the document table is selected, the control unit ends the mode based on an instruction issued by a user to end in any one of a document cover open waiting state in which the open state of the document cover is waited, a placement waiting state in which placement of a document on the document table is waited, a removal waiting state in which the document for which reading is ended is to be removed from the document table, and a post-cancellation instruction waiting state in which an instruction is waited after the reading of a document is cancelled by the user. According to the configuration, since it is possible to continuously read a plurality of documents until a predetermined condition is satisfied, it is possible to improve convenience for the user.

The image reading apparatus according to may display information and further include an input unit configured to receive an input from the user. The control unit displays an end button for receiving an end of the mode in the document cover open waiting state, the placement waiting state, the removal waiting state, and the post-cancellation instruction waiting state, ends the mode based on pressing of the end button, and converts the read image data into a PDF. According to the configuration, since a plurality of documents can be continuously read until the predetermined condition is satisfied, it is possible to improve convenience for the user.

What is claimed is:

1. An image reading apparatus comprising: a document table having a placement surface on which a document is to be placed; a document cover configured to open and close the placement surface of the document table; a reading unit configured to read a document placed on the placement surface of the document table on an opposite side from the placement surface; and a control unit, wherein when a mode in which reading of a plurality of documents is continuously performed for each of the documents in an open state in which the document cover is opened with respect to the document table is selected, the control unit ends the mode based on a predetermined condition being satisfied in a removal waiting state in which a document for which reading is ended is to be removed from the document table.

2. The image reading apparatus according to claim 1, wherein the predetermined condition is that a predetermined time elapses in the removal waiting state.

3. The image reading apparatus according to claim 2, wherein the control unit continues the mode based on detecting that the document is placed on the document table after detecting that a document is removed before the predetermined time elapses in the removal waiting state.

5. The image reading apparatus according to claim 1, wherein the predetermined condition is that an end of the mode is instructed by a user.

4. The image reading apparatus according to claim 1, further comprising: an opening and closing sensor configured to detect opening and closing of the document cover, wherein the predetermined condition is that the opening and closing sensor detects a closed state of the document cover in the removal waiting state.

6. The image reading apparatus according to claim 1, wherein when it is detected that a document is placed on the placement surface based on a result of causing the reading unit to read in a state in which the document cover is opened, the control unit executes a document reading process of causing the reading unit to read the document, and, when it cannot be detected that a document is placed on the placement surface, the control unit shifts to a manual mode of performing reading manually by a user.

7. The image reading apparatus according to claim 1, wherein the control unit shifts to the removal waiting state when the reading of the document is canceled by a user.

8. The image reading apparatus according to claim 1, further comprising: a display unit configured to display information; and an input unit configured to receive an input from a user, wherein the control unit causes the display unit to display a resumption reception image indicating that resumption of the mode is received when the mode is canceled by the user, and resumes the mode based on an instruction to resume the mode by the user via the input unit.

9. The image reading apparatus according to claim 1, wherein when ending the mode based on the predetermined condition being satisfied, the control unit converts read image data into a PDF.

10. An image reading apparatus comprising: a document table having a placement surface on which a document is to be placed; a document cover configured to open and close the placement surface of the document table; a reading unit configured to read a document placed on the placement surface of the document table on an opposite side from the placement surface; and a control unit, wherein when a mode in which reading of a plurality of documents is continuously performed for each of the documents in an open state in which the document cover is opened with respect to the document table is selected, the control unit ends the mode based on an instruction issued by a user to end in any one of a document cover open waiting state in which the open state of the document cover is waited, a placement waiting state in which placement of a document on the document table is waited, a removal waiting state in which a document for which reading is ended is to be removed from the document table, and a post-cancellation instruction waiting state in which an instruction is waited after the reading of the document is cancelled by the user.

11. The image reading apparatus according to claim 10, displaying information and further comprising an input unit configured to receive an input from the user, wherein the control unit displays an end button for receiving an end of the mode in the document cover open waiting state, the placement waiting state, the removal waiting state, and the post-cancellation instruction waiting state, ends the mode based on pressing of the end button, and converts the read image data into a PDF.
